(19) United States
(12) Patent Application Publication
(10) Pub. No.: US 2024/0020596 A1
(43) Pub. Date: Jan. 18, 2024

(54) CUSTOMER SERVICE MANAGEMENT APPARATUS, CUSTOMER SERVICE MANAGEMENT SYSTEM, CUSTOMER SERVICE MANAGEMENT METHOD, AND COMPUTER PROGRAM

(71) Applicant: KONICA MINOLTA, INC., Tokyo (JP)

(72) Inventor: Yasufumi NAITOU, Toyokawa shi (JP)

(73) Assignee: KONICA MINOLTA, INC., Tokyo (JP)

(21) Appl. No.: 18/202,746

(22) Filed: May 26, 2023

(30) Foreign Application Priority Data
Jul. 12, 2022 (JP) 2022-111712

(51) Int. Cl. G06Q 10/0631; G06V 40/20

(52) U.S. Cl. CPC G06Q 10/063112; G06V 40/20

(57) ABSTRACT

A customer service management apparatus that manages a customer service method for a customer staying in a predetermined region, includes: a receiver that receives an image generated by image-capturing with a plurality of customers as subjects; a customer service determiner that determines whether or not customer service is necessary for each of the customers on the basis of the received image; and a hardware processor that determines, when it is determined that customer service is necessary for a plurality of customers, an order of customer service for the plurality of customers for which customer service is necessary.

The entire disclosure of Japanese patent Application No. 2022-111712, filed on Jul. 12, 2022, is incorporated herein by reference in its entirety.

### BACKGROUND

### Technological Field

The present disclosure relates to a technique for managing a customer service method for a customer staying in a predetermined region.

### Description of the Related Art

When selling goods or providing services, customer service for customers is necessary.

According to JP 2009-248193 A, in a customer service system in which a robot capable of autonomously moving in a predetermined region serves a person present in the region, an interest degree determination unit determines an interest degree of the person present in the region with respect to the robot on the basis of image information collected by an imaging unit.

Specifically, when it is determined that the person is not in a certain region, the degree of interest of the person is set to zero. When the face of the person does not face the robot although the person is in the certain region, the degree of interest is set to one. When the face faces the robot but the line of sight is not directed to the robot, the degree of interest is set to two. When the line of sight is directed to the robot and a predetermined gesture or utterance is not performed, the degree of interest is set to three. When a predetermined gesture or utterance is performed, the degree of interest is set to four.

A customer service scheduling unit determines an order in which the robot serves a person present in the region by using the degree of interest obtained by the determination. A robot operation control unit causes the robot to perform operations such as approach to a person, gesture, utterance of guidance, and guidance to a predetermined place on the basis of the order determined by the customer service scheduling unit.

For example, in a case where the robot is arranged in a store where a product is sold, the robot serves a customer interested in the robot as described above. However, the robot does not serve customers who are not interested in the robot. Even when such a customer desires to know the location of a product or desires to know details of the product, the robot does not serve the customer, so that the store side cannot grasp the customer's desire.

Further, for example, in a store that provides a copy service or the like by a multifunction peripheral (MFP) or a store that provides a cash payment service by an automatic teller machine (ATM), when a customer who is not interested in the robot is in a situation in which the customer is in trouble because the customer does not know how to operate an apparatus such as an MFP or an ATM, the store side cannot grasp the situation of the customer because the robot does not serve the customer as described above.

### SUMMARY

An object of the present disclosure is to provide a customer service management apparatus, a customer service management system, a customer service management method, and a computer program capable of grasping a situation of a customer on a store side and managing a customer service method for the customer regardless of the presence of a robot.

To achieve the abovementioned object, according to an aspect of the present invention, a customer service management apparatus that manages a customer service method for a customer staying in a predetermined region. reflecting one aspect of the present invention comprises: a receiver that receives an image generated by image-capturing with a plurality of customers as subjects; a customer service determiner that determines whether or not customer service is necessary for each of the customers on the basis of the received image; and a hardware processor that determines, when it is determined that customer service is necessary for a plurality of customers, an order of customer service for the plurality of customers for which customer service is necessary.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates a configuration of a customer service management system according to a first embodiment;

FIG. 2 is a block diagram illustrating a configuration of a customer service management apparatus according to the first embodiment;

FIG. 3 is a block diagram illustrating a configuration of a typical neural network;

FIG. 4 is a schematic diagram illustrating one neuron of the neural network;

FIG. 5 is a diagram schematically illustrating a propagation model of data during preliminary learning (training) in the neural network;

FIG. 6 is a diagram schematically illustrating a propagation model of data at a time of practical inference in the neural network;

FIG. 7 is a block diagram illustrating a relationship between each component of a recognition processing unit and each piece of data of a storage device;

FIG. 8 illustrates an example of a data structure of a customer list;

FIG. 9 illustrates an example of a data structure of posture data;

FIG. 10 illustrates an example of a data structure of object data;

FIG. 11 illustrates an example of a number of objects;

FIG. 12 illustrates an example of a data structure of entry and exit data;

FIG. 13 is a flowchart illustrating an operation in the customer service management apparatus according to the first embodiment;

FIG. 14 is a flowchart illustrating an operation in the recognition processing unit;

FIG. 15 illustrates a state in which a priority order is increased in customer lists;

FIG. 16A illustrates an example of a data structure of a customer service time table of a second embodiment; FIG. 16B illustrates an example of a data structure of a customer list of the second embodiment; FIG. 16C illustrates a lapse of time in a case of one combination of customers and staffs in the second embodiment; FIG. 16D illustrates a lapse of time in a case of customers and the staffs combined so that customer service is completed in a short time in the second embodiment; and

FIG. 17 is a flowchart illustrating an operation in the customer service management apparatus according to the second embodiment.

### DETAILED DESCRIPTION OF EMBODIMENTS

Hereinafter, one or more embodiments of the present invention will be described with reference to the drawings. However, the scope of the invention is not limited to the disclosed embodiments.

### 1. First Embodiment

### 1.1 Customer Service Management System 1

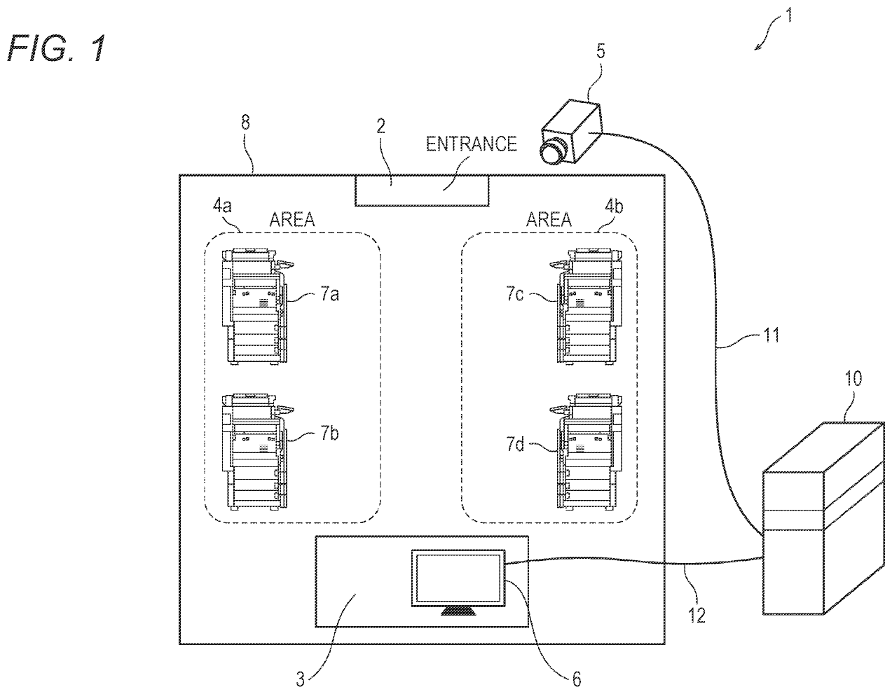

A customer service management system 1 of a first embodiment will be described with reference to FIG. 1.

The customer service management system 1 includes a camera 5 (imaging device), a monitor 6, and a customer service management apparatus 10. As an example, the customer service management system 1 is installed in a store 8 that provides a copy service or the like to a customer. Here, the inside of the store 8 is referred to as a predetermined region.

The customer enters the store 8 from an entrance 2. The customer manually operates any one of MFPs 7a, 7b, 7c, and 7d to perform copying or the like. After copying or the like, the customer pays for copying or the like at a reception counter 3. After payment for copying or the like, the customer leaves the store 8 from the entrance 2.

The inside of the store 8 is divided into an area 4a (sub region) and an area 4b (sub region). The MFPs 7a and 7b are installed in the area 4a, and MFPs 7c and 7d are installed in the area 4b.

The camera 5 includes a lens that collects light from a subject and forms an image on an imaging element, an imaging element such as a charge coupled device (CCD) that converts emitted light into an electric signal through the lens, and an image processing engine that converts the generated electric signal into a digital frame image.

The camera 5 is fixed at a predetermined position in the store 8, fixed in a predetermined direction, and installed so as to be able to capture an image of the inside of the store 8. The camera 5 is connected to the customer service management apparatus 10 via a cable 11.

The camera 5 captures an image of the inside of the store 8 and generates a frame image. Since the camera 5 continuously captures an image of the inside of the store 8, the camera 5 generates a plurality of frame images. In this manner, the camera 5 generates a moving image (images) including a plurality of frame images. The camera 5 transmits the moving image to the customer service management apparatus 10 as needed. The customer service management apparatus 10 receives the moving image from the camera 5.

The customer service management apparatus 10 analyzes the moving image received from the camera 5, recognizes a person (object) included in the moving image, and recognizes the action of the person. For example, it is recognized from the moving image that a person has entered the store from the entrance 2, that a person has left the store from the entrance 2, that a person standing in front of an MFP is operating the MFP, that a person standing in front of the MFP is holding his or her head with both hands, that a person standing in front of the MFP is raising one hand or both hands above his or her head, that a person standing in front of the MFP is placing his or her hand on the chin, and the like.

The customer service management apparatus 10 manages a customer service method for a customer staying in the store 8.

As described above, a moving image (video) includes a plurality of frame images, and each frame image includes a plurality of pixels arranged in a matrix. Each frame image includes an object such as a person. Further, each frame image includes the time (year, month, day, hour, minute, and second) at which the frame image is generated.

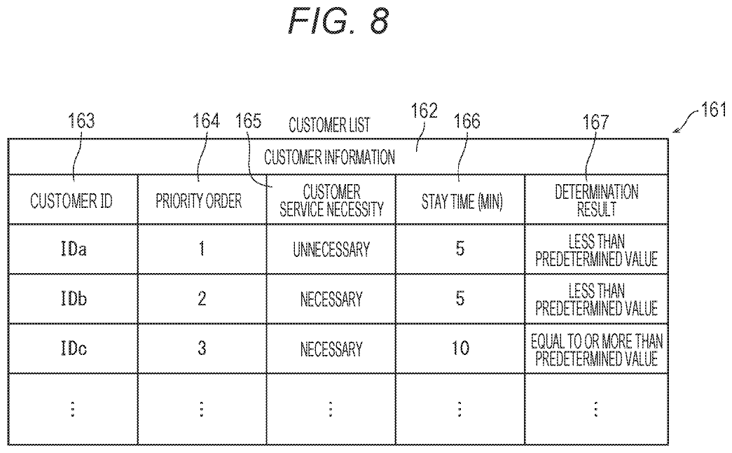

The monitor 6 is provided in the reception counter 3. The monitor 6 is connected to the customer service management apparatus 10 via a cable 12. The monitor 6 receives a customer list 161 (see FIG. 8) to be described later from the customer service management apparatus 10 and displays the received customer list 161.

For example, one staff may be arranged in the store 8. The staff of the store 8 looks at the customer list 161 displayed on the monitor 6 and performs customer service for the customer.

### 1.2 Customer Service Management Apparatus 10

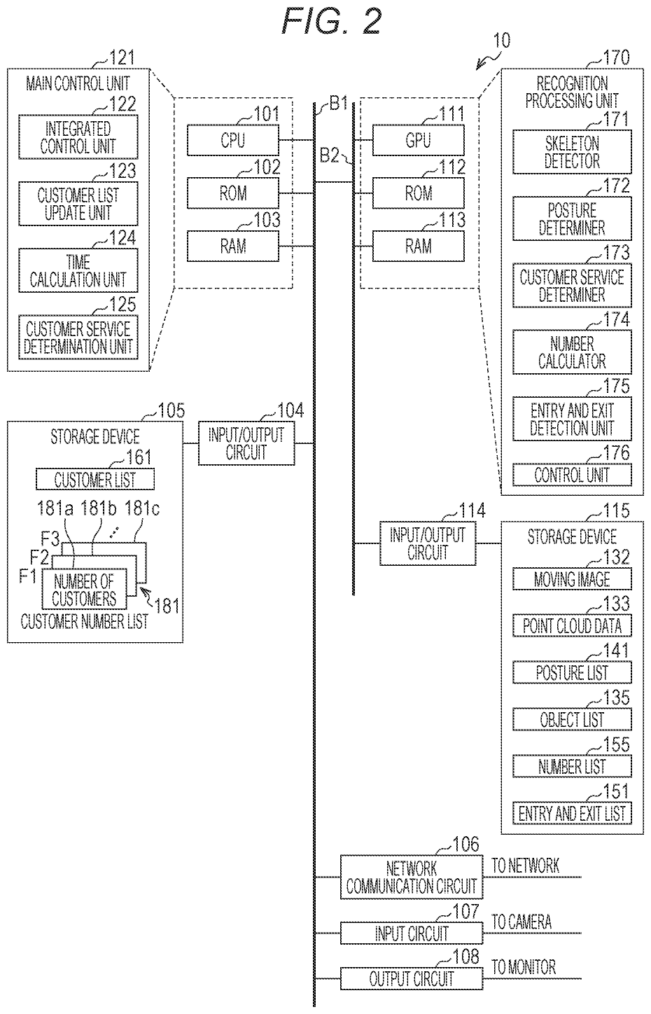

As illustrated in FIG. 2, the customer service management apparatus 10 includes a central processing unit (CPU) 101, a read only memory (ROM) 102, a random access memory (RAM) 103, an input/output circuit 104, a network communication circuit 106, an input circuit 107, and an output circuit 108 connected to a bus B1, and a graphics processing unit (GPU) 111, a ROM 112, a RAM 113, and an input/output circuit 114 connected to a bus B2. The bus B1 and the bus B2 are connected to each other. A storage device 105 is connected to the input/output circuit 104. Further, a storage device 115 is connected to the input/output circuit 114.

(1) CPU 101, ROM 102, and RAM 103

The RAM 103 includes a semiconductor memory, and provides a work area when the CPU 101 executes a program.

The ROM 102 includes a semiconductor memory. The ROM 102 stores a control program which is a computer program for executing processing in the customer service management apparatus 10, and the like.

The CPU 101 is a processor that operates according to the control program stored in the ROM 102.

By the CPU 101 operating according to the control program stored in the ROM 102 using the RAM 103 as a work area, the CPU 101, the ROM 102, and the RAM 103 constitute a main control unit 121.

(2) Network Communication Circuit 106

The network communication circuit 106 is connected to an external information terminal via a network. The network communication circuit 106 relays transmission and reception of information to and from an external information terminal via a network. For example, the network communication circuit 106 transmits the customer list 161 to an external information terminal via a network.

(3) Input Circuit 107

The input circuit 107 (receiver) is connected to the camera 5 via the cable 11.

The input circuit 107 receives a moving image from the camera 5 and writes the received moving image into the storage device 115 via the bus B1, the bus B2, and the input/output circuit 114.

The input circuit 107 receives a moving image (images) generated by image-capturing with a plurality of customers as subjects.

(4) Output Circuit 108

The output circuit 108 is connected to the monitor 6 via the cable 12.

The output circuit 108 receives the customer list 161 from the main control unit 121, and outputs the received customer list 161 to the monitor 6 for display.

(5) Storage Device 105

The storage device 105 includes, for example, a hard disk drive.

As illustrated in FIG. 2, the storage device 105 includes a region for storing the customer list 161 and the customer number list 181. Further, the storage device 105 stores a staff ID for identifying a staff.

(Customer List 161)

As illustrated in FIG. 8, the customer list 161 includes a plurality of pieces of customer information 162.

Each piece of the customer information 162 corresponds to each customer who enters the store 8.

Each piece of the customer information 162 includes a customer ID (163), a priority order 164, customer service necessity 165, stay time 166, and a determination result 167.

The customer ID (163) is identification information for uniquely identifying a customer.

The priority order 164 is a priority order assigned to the customer, and customer service is performed according to the priority order. That is, the priority order 164 indicates the order (rank) of customer service of the customer. The priority order takes an integer value of 1 or more, such as “1”, “2”, “3”, . . . , or the like. The smaller the value, the higher the priority order. For example, in a case where “1” is assigned to the customer a and “2” is assigned to the customer b, first, customer service for the customer a is performed. When the customer service for the customer a is finished, next, the service to the customer b is performed.

Note that the priority order 164 is initially determined according to the order in which the customer enters the store 8 (that is, before the customer service order described later is increased).

The customer service necessity 165 indicates to the customer whether or not the customer service is necessary. The customer service necessity 165 takes either “unnecessary” or “necessary”. The customer service necessity 165 “unnecessary” indicates to the customer that the customer service is unnecessary. “Necessary” of the customer service necessity 165 indicates to the customer that the customer service is necessary.

The stay time 166 indicates a time (minutes) from when the customer enters the store 8 to the present time.

The determination result 167 indicates whether the stay time 166 is equal to or more than a predetermined threshold value or less than the predetermined threshold value. The predetermined threshold value varies depending on the type of a device (electronic device) such as an MFP installed in the store 8, the size of the store 8, the total number of staffs belonging to the store 8, and the like. Here, the predetermined threshold value is, for example, 7 minutes.

When the customer enters the store 8, one piece of customer information is newly generated in the customer list 161. When the customer leaves the store 8, the customer information corresponding to the customer is deleted from the customer list 161.

(Customer Number List 181)

The customer number list 181 includes a plurality of numbers of customers 181a, 181b, 181c, . . . , as illustrated in FIG. 2. Each of the numbers of customers 181a, 181b, 181c, . . . indicates the number of customers staying in the store 8 at a plurality of time points. One of the numbers of customers 181a, 181b, 181c, . . . is the number of customers in the latest state.

(6) Storage Device 115

The storage device 115 includes a semiconductor memory. The storage device 115 is, for example, a solid state drive (SSD).

As illustrated in FIG. 2, the storage device 115 includes a region for storing a moving image 132, point cloud data 133, a posture list 141, an object list 135, a number list 155, and an entry and exit list 151. Further, the storage device 115 stores range coordinate values in the frame image indicating a range occupied by the area 4a reflected in the frame image, and stores range coordinate values in the frame image indicating a range occupied by the area 4b reflected in the frame image.

(Moving Image 132)

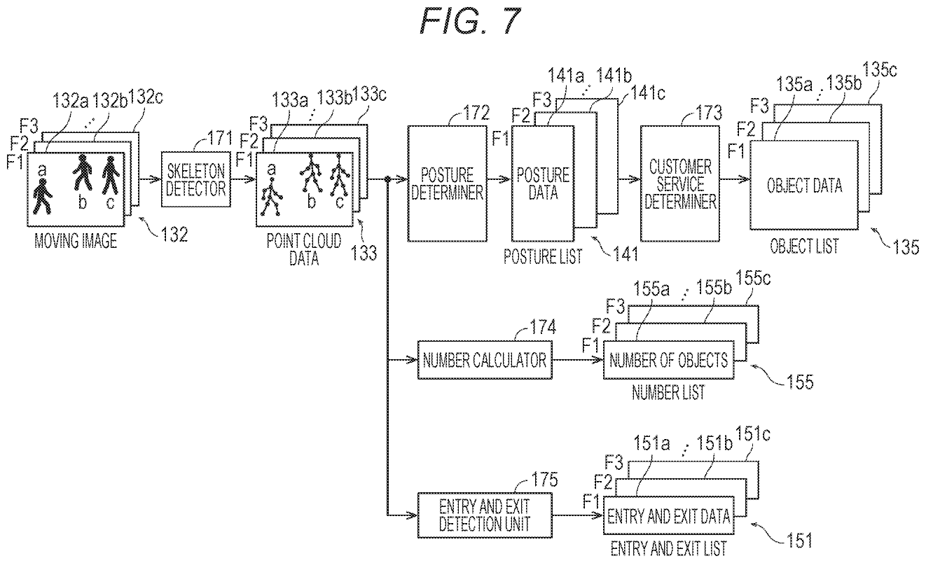

The moving image 132 is a moving image generated by image-capturing by the camera 5. The moving image 132 includes, for example, frame images 132a, 132b, 132c, . . . (see FIG. 7). The frame images 132a, 132b. 132c . . . are indicated by F1, F2, F3, . . . , respectively.

(Point Cloud Data 133)

The point cloud data 133 includes frame point clouds 133a, 133b, 133c, . . . (see FIG. 7). The frame point clouds 133a, 133b, 133c, . . . respectively correspond to frame images 132a, 132b, 132c, . . . included in moving image 132. Each of the frame point clouds 133a, 133b, 133c, . . . includes a time (year, month, day, hour, minute, and second) at which each of the corresponding frame images 132a, 132b, 132c, . . . is generated.

Each of the frame point clouds 133a, 133b, 133c, . . . includes a plurality of skeleton points detected from the frame images 132a, 132b, 132c, . . . by a skeleton detector 171 to be described later.

Note that, in order to facilitate understanding of association between the moving image 132 and the point cloud data 133, in FIG. 7, the point cloud data 133 is expressed so as to include the frame point clouds 133a, 133b, 133c, . . . corresponding to the frame images 132a, 132b, 132c . . . , respectively, included in the moving image 132.

However, actually, in the point cloud data 133, one skeleton point is indicated by an X coordinate value, a Y coordinate value, and a time axis coordinate value (time). That is, one skeleton point is indicated by coordinate values (X coordinate value, Y coordinate value) of a position where a joint point of an object (that is, a person) exists in the frame image and a coordinate value (time t) on a time axis corresponding to the frame image in which the joint point exists. Therefore, a point cloud does not exist in a data format such as the frame point clouds 133a, 133b, 133c, . . . illustrated in FIG. 7, and thus it is necessary to pay attention. Hereinafter, a similar expression method is employed.

(Posture List 141)

The posture list 141 includes a plurality of pieces of posture data 141a, 141b, 141c, . . . as illustrated in FIG. 7. The posture data 141a, 141b, 141c, . . . are generated based on the point cloud data 133 by a posture determiner 172 to be described later.

The posture data 141a, 141b, 141c, . . . correspond to the frame point clouds 133a, 133b, 133c, . . . respectively.

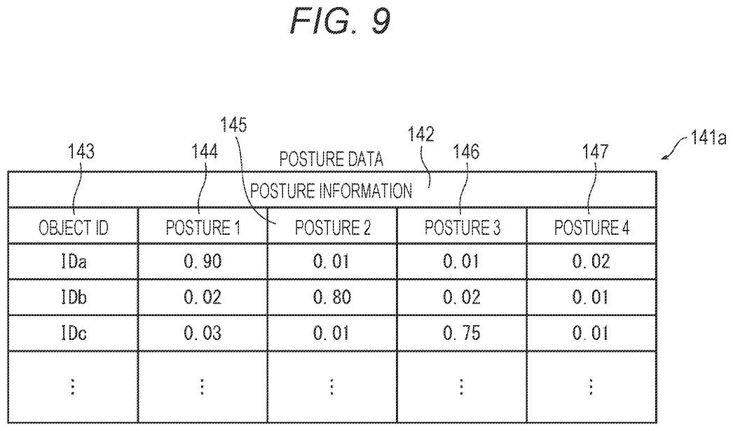

As illustrated in FIG. 9, the posture data 141a includes a plurality of pieces of posture information 142. Each piece of the posture information corresponds to each object.

The posture information 142 includes an object ID (143), a posture 1 (144), a posture 2 (145), a posture 3 (146), and a posture 4 (147).

The object ID (143) is identification information for uniquely identifying the object.

The posture 1 (144) indicates a probability that the object takes one posture, for example, a posture in which a person is standing upright and is operating the MFP with the right hand, with a value between 0.0 and 1.0. The closer the value of the posture 1 (144) is to “1.0”, the closer the posture of the object is to the posture in which the person is standing upright and is operating the MFP with the right hand. Further, this posture indicates that the person can operate the MPF without requesting customer service.

Furthermore, the posture 2 (145) indicates a probability that the object takes one posture, for example, a posture in which a person is standing upright and holds his or her head with both hands, with a value between 0.0 and 1.0. The closer the value of the posture 2 (145) is to “1.0”, the closer the posture of the object is to the posture in which the person is standing upright and holds his or her head with both hands. Further, this posture indicates that the person does not know how to operate the MPF and is in trouble, and indicates that the person requests the staff for customer service.

Furthermore, the posture 3 (146) indicates a probability that the object takes one posture, for example, a posture in which a person is standing upright and raises one hand above the shoulder, with a value between 0.0 and 1.0. The closer the value of the posture 3 (146) is to “1.0”, the closer the posture of the object is to the posture in which the person is standing upright and raises one hand above the shoulder. Further, this posture indicates that the person requests the staff to for customer service.

Further, the posture 4 (147) indicates a probability that the object takes one posture, for example, a posture in which a person is standing upright and one hand is placed on the chin, with a value between 0.0 and 1.0. The closer the value of the posture 4 (147) is to “1.0”, the closer the posture of the object is to the posture in which the person is standing upright and one hand is placed on the chin. Further, this posture indicates that the person does not know how to operate the MPF and is in trouble, and indicates that the person requests the staff for customer service.

The posture information 142 may include postures other than the posture 1 (144), the posture 2 (145), the posture 3 (146), and the posture 4 (147).

The posture data 141b and the posture data 141c, . . . also have the same data structure as the posture data 141a.

(Object List 135)

The object list 135 includes a plurality of pieces of object data 135a, 135b, 135c, . . . as illustrated in FIG. 7. The object data 135a, 135b, 135c, . . . are generated on the basis of the posture list 141 by a customer service determiner 173 to be described later.

The object data 135a, 135b, 135c, . . . correspond to the posture data 141a, 141b, 141c, . . . , respectively.

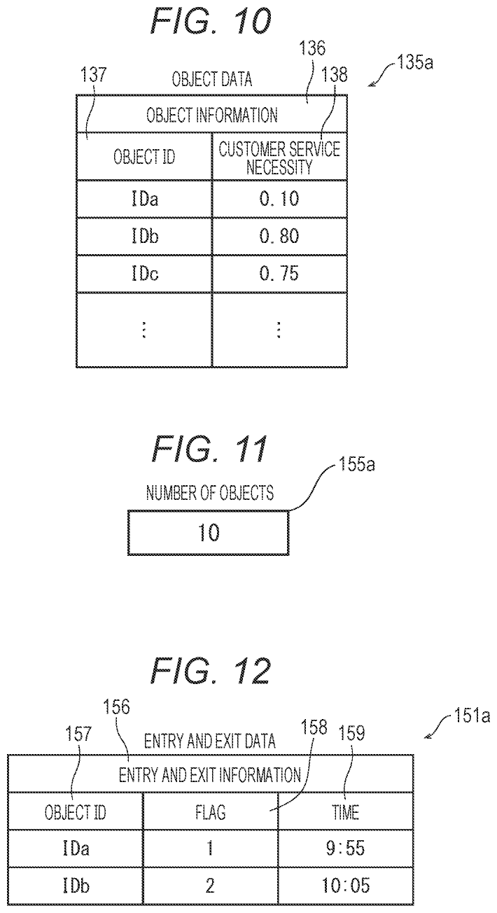

As illustrated in FIG. 10, the object data 135a includes a plurality of pieces of object information 136. Each piece of the object information corresponds to each object.

The object information 136 includes an object ID (137) and a customer service necessity 138.

The object ID (137) is identification information for uniquely identifying the object.

The customer service necessity 138 indicates whether or not the customer service is necessary for the person of the object with a value between 0.0 and 1.0. The closer the value of the customer service necessity 138 is to “1.0”, the more the customer service is necessary. The closer the value of the customer service necessity 138 is to “0.0”, the less the customer service is necessary.

The object data 135b, 135c, . . . also have the same data structure as the object data 135a.

(Number List 155)

The number list 155 includes a plurality of numbers of objects 155a, 155b, 155c . . . , as illustrated in FIG. 7. The numbers of objects 155a, 155b, 155c, . . . are generated on the basis of the point cloud data 133 by a number calculator 174 to be described later. The numbers of objects 155a, 155b, 155c, . . . correspond to the frame point clouds 133a, 133b, 133c, . . . , respectively.

As illustrated in FIG. 11, the number of objects 155a indicates the number of objects included in the frame image, that is, the number of customers. The number of objects 155b, 155c, . . . is also similar to the number of objects 155a.

(Entry and Exit List 151)

The entry and exit list 151 includes, for example, a plurality of pieces of entry and exit data 151a, 151b, 151c, . . . , as illustrated in FIG. 7. In the example illustrated in FIG. 7, the pieces of entry and exit data 151a, 151b, 151c, . . . correspond to the frame point clouds 133a, 133b, 133c, . . . , respectively. Note that there may be a case where there is no entry and exit data corresponding to the frame point cloud.

Each piece of the entry and exit data indicates the presence of a customer who is about to enter the store 8 or a customer who is about to exit from the store 8 in the corresponding frame point cloud.

As illustrated in FIG. 12, the entry and exit data 151a includes a plurality of pieces of entry and exit information 156. Note that the entry and exit data 151a may include one piece of the entry and exit information 156.

Each piece of the entry and exit information 156 corresponds to an object (customer) who is about to enter the store 8 or an object (customer) who is about to exit from the store 8 in the corresponding frame point cloud 133a.

Each piece of the entry and exit information 156 includes an object ID (157), a flag 158, and a time 159.

The object ID (157) is identification information for uniquely identifying an object, that is, a customer.

The flag 158 indicates whether the object, that is, the customer is about to enter the store 8 or the object is about to exit from the store 8. The flag 158 “1” indicates that the object is about to enter the store 8. On the other hand, the flag 158 “2” indicates that the object is about to exit from the store 8.

The time 159 is a time at which the object enters the store 8 or a time at which the object exits from the store 8.

For example, as illustrated in FIG. 12, when an object (customer) is about to enter the store 8, one piece of the entry and exit information includes an object ID “IDa”, a flag “1”, and a time “9:55”. Further, when the object (customer) is about to exit from the store 8, one piece of the entry and exit information includes an object ID “IDb”, a flag “2”, and a time “10:05”.

(7) Main Control Unit 121

The main control unit 121 functionally constitutes an integrated control unit 122, a customer list update unit 123, a time calculation unit 124, and a customer service determination unit 125 by the CPU 101 operating according to a control program stored in the ROM 102 using the RAM 103 as a work area.

(a) Integrated Control Unit 122

The integrated control unit 122 integrally controls the entire customer service management apparatus 10.

Further, the integrated control unit 122 integrally controls the customer list update unit 123, the time calculation unit 124, and the customer service determination unit 125.

Further, when the input circuit 107 receives the moving image from the camera 5, the integrated control unit 122 performs control to write the received moving image in the storage device 115 via the bus B1, the bus B2, and the input/output circuit 114.

Further, upon receiving the moving image for the first time, the integrated control unit 122 outputs an instruction to start the recognition processing to the recognition processing unit 170 to be described later.

Further, the integrated control unit 122 regularly and repeatedly receives a set of the object data and the number of objects from the recognition processing unit 170 via the bus B2 and the bus B1.

For example, at time t1, the integrated control unit 122 receives the set of the object data 135a and the number of objects 155a. Next, at time t2 after a lapse of a predetermined time from time t1, a set of the object data 135b and the number of objects 155b is received. Next, at time t3 after a lapse of a predetermined time from time 2, a set of the object data 135c and the number of objects 155c is received. Here, the predetermined time is, for example, 0.1 seconds.

Further, the integrated control unit 122 irregularly receives the entry and exit data from the recognition processing unit 170 via the bus B2 and the bus B1.

Upon receiving the object data, the integrated control unit 122 outputs the received object data to the customer list update unit 123.

Upon receiving the number of objects, the integrated control unit 122 outputs the received number of objects to the customer list update unit 123.

Upon receiving the entry and exit data, the integrated control unit 122 outputs the received entry and exit data to the customer list update unit 123 and the time calculation unit 124.

Further, the integrated control unit 122 receives a notification from the customer list update unit 123 that processing of the customer list 161 has been completed. Upon receiving this notification, as will be described later, the integrated control unit 122 performs control to read the associated customer list 161 and staff ID from the storage device 105 via the input/output circuit 104, output the read customer list 161 and staff ID to the output circuit 108, and display them on the monitor 6.

(b) Customer List Update Unit 123

(Registration and Deletion of Customer ID)

The customer list update unit 123 irregularly receives entry and exit data (see FIGS. 7 and 12) from the integrated control unit 122. Here, the timing of receiving the entry and exit data is when the customer enters the store 8 or when the customer exits from the store 8.

Upon receiving the entry and exit data 151a, the customer list update unit 123 executes the following processing for each piece of the entry and exit information 156 included in the entry and exit data 151a.

The customer list update unit 123 determines whether the flag 158 included in the entry and exit information 156 is “1” or “2”. As described above, the flag 158 “1” indicates that the object (customer) is about to enter the store 8. On the other hand, the flag 158 “2” indicates that the object is about to exit from the store 8.

When it is determined that the flag 158 included in the entry and exit information 156 is “1”, the customer list update unit 123 sets the object ID (157) included in the entry and exit information 156 as a customer ID, generates customer information including the customer ID, and writes the generated customer information in the customer list 161 of the storage device 105 via the input/output circuit 104.

As described above, when the customer information is newly written in the customer list 161, the customer list update unit 123 searches for the lowest priority among all the priorities set in the customer list 161, and newly sets the lower priority next to the lowest priority order obtained by the search.

For example, in a case where the priority orders “1”, “2”, and “3” are set in the customer list 161, the priority order “3” is the lowest priority order, and thus the priority order “4” that is the lower priority order next to the priority order “3” is set. The customer list update unit 123 writes the set priority (for example, the priority order “4”) in the customer list 161 as the priority of the new customer information written in the customer list 161.

On the other hand, when it is determined that the flag 158 included in the entry and exit information 156 is “2”, the customer list update unit 123 deletes the customer information including the object 1D (157) included in the entry and exit information 156 as the customer ID from the customer list 161 of the storage device 105 via the input/output circuit 104.

(Determination of Customer Service Necessity)

The customer list update unit 123 receives the object data from the integrated control unit 122. Here, it is assumed that the object data 135a illustrated in FIG. 10 is received.

Upon receiving the object data 135a, the customer list update unit 123 repeats the following process (i) for each of all pieces of the object information 136 included in the received object data 135a.

(i) Regarding one piece of the object information 136 included in the received object data 135a, it is determined whether or not the customer service necessity 138 included in the object information 136 is equal to or more than a predetermined customer service necessity threshold value. Here, the customer service necessity threshold value is, for example, “0.7”.

Next, the following processing is performed on the customer information 162 including the same customer ID as the object ID (137) included in the received object information 136 in the customer list 161.

When the customer service necessity 138 included in the object information 136 is equal to or more than the customer service necessity threshold value, the customer service necessity 165 included in the customer information 162 is set as “necessary”, and the customer service necessity 165 “necessary” is written in the customer information 162 via the input/output circuit 104.

On the other hand, when the customer service necessity 138 included in the object information 136 is less than the customer service necessity threshold value, the customer service necessity 165 included in the customer information 162 is set to “unnecessary”, and the customer service necessity 165 “unnecessary” is written in the customer information 162 via the input/output circuit 104. [End of processing of (i)]

Next, the customer list update unit 123 controls the time calculation unit 124 to write the stay time calculated for each customer ID in the customer list 161.

Next, for each piece of the customer information 162 in the customer list 161, the customer list update unit 123 determines whether or not the stay time included in the customer information 162 is equal to or more than a predetermined stay time threshold value. Here, the stay time threshold value is, for example, 8 minutes.

When it is determined that the stay time included in each piece of the customer information 162 in the customer list 161 is equal to or more than the stay time threshold value, the customer list update unit 123 writes the determination result “equal to or more than predetermined time” to the customer information 162 via the input/output circuit 104.

On the other hand, when it is determined that the stay time included in each piece of the customer information 162 in the customer list 161 is less than the stay time threshold value, the customer list update unit 123 writes the determination result “less than predetermined value” to the customer information 162 via the input/output circuit 104.

Next, the customer list update unit 123 repeats the following processes (ii) to (iii) for each of all pieces of the customer information included in the customer list 161.

(ii) The customer list update unit 123 (determiner) determines, for one piece of the customer information 162, whether the customer service necessity 165 included in the customer information 162 is “necessary” or “unnecessary” among all pieces of the customer information included in the customer list 161.

(ii-1) When it is determined that, for one piece of the customer information 162, the customer service necessity 165 included in the customer information 162 is “unnecessary”, the customer list update unit 123 does nothing. [End of process of (ii-1)]

(ii-2) When it is determined that, for one piece of the customer information 162, the customer service necessity 165 included in the customer information 162 is “necessary”, the customer list update unit 123 increases the priority order 164 included in the customer information 162 by one.

That is, when the customer service determiner 173 determines that customer service is necessary for one customer, the customer list update unit 123 determines to increase the order of customer service by one for the customer.

For example, when the priority order 164 included in the customer information 162 is “3”, the customer list update unit 123 changes the priority order 164 included in the customer information 162 to “2”, and writes the changed priority order in the customer list 161 via the input/output circuit 104.

On the other hand, before updating the priority order, the customer list update unit 123 updates the original priority order “2” to the priority order “3” for the customer information including the original priority order “2”, and writes the customer information in the customer list 161 via the input/output circuit 104.

Here, in a case where the priority order of the target to be increased is “1”, the customer list update unit 123 does not perform any further increase. [End of process (ii-2)]

(iii) The customer list update unit 123 performs the following determination on each of all pieces of customer information including the customer service necessity “necessary” among all pieces of the customer information included in the customer list 161.

That is, the customer list update unit 123 determines whether the determination result 167 included in the customer information 162 is “equal to or more than predetermined value” or “less than predetermined value” for each of all the customer information including the customer service necessity “necessary”.

When it is determined that the determination result 167 included in the customer information 162 is “less than predetermined value”, the customer list update unit 123 does nothing.

On the other hand, when it is determined that the determination result 167 included in the customer information 162 is “equal to or more than predetermined value”, the customer list update unit 123 increases the priority order 164 included in the customer information 162 by one as described above.

That is, the customer list update unit 123 determines whether or not the time calculated by the time calculation unit 124 is equal to or more than a predetermined threshold value for the customer for which it is determined that customer service is necessary, and when it is determined that the calculated time is equal to or more than the predetermined threshold value, the customer list update unit 123 determines to increase the order of customer service by one for the customer.

As described above, the customer list update unit 123 determines the order (rank) of customer service by using the time calculated by the time calculation unit 124 for a plurality of customers for which it is determined that customer service is necessary by the customer service determiner 173. [End of process (iii)]

As described above, when the customer service determiner 173 determines that customer service for a plurality of customers is necessary, the customer list update unit 123 determines the order of customer service for a plurality of customers for which it is determined that customer service is necessary.

Next, when the repetition of the processes (ii) to (iii) is completed, the customer list update unit 123 notifies the integrated control unit 122 that the process of the customer list 161 is completed.

(c) Time Calculation Unit 124

The time calculation unit 124 (time calculator) calculates the time during which each of the plurality of customers stays in the store 8 as described below.

The time calculation unit 124 irregularly receives entry and exit data (see FIGS. 7 and 12) from the integrated control unit 122. Here, as described above, the timing of receiving the entry and exit data is when the customer enters the store 8 or when the customer exits from the store 8.

As an example, when the entry and exit data 151a illustrated in FIG. 12 is received, the time calculation unit 124 executes the following processing for each piece of the entry and exit information 156 included in the entry and exit data 151a.

The time calculation unit 124 determines whether the flag 158 included in the entry and exit information 156 is “1” or “2”. As described above, the flag 158 “l” indicates that the object (customer) is about to enter the store 8. On the other hand, the flag 158 “2” indicates that the object is about to exit from the store 8.

When it is determined that the flag 158 included in the entry and exit information 156 is “I”, since the object is about to enter the store 8, the time calculation unit 124 starts measurement of the stay time of the customer indicated by the object ID (157) (that is, the customer ID) included in the entry and exit information 156 from the time 159 included in the entry and exit information 156.

On the other hand, when it is determined that the flag 158 included in the entry and exit information 156 is “2”, since the object is about to exit from the store 8, the time calculation unit 124 ends the measurement of the stay time of the customer indicated by the object ID (157) (that is, the customer ID).

As described above, for each customer ID, while the customer identified by the customer ID stays in the store 8, the time calculation unit 124 measures the stay time of the customer in the store 8. When the customer exits from the store 8, the measurement of the stay time is stopped.

Under the control of the customer list update unit 123, the time calculation unit 124 writes the stay time calculated for each customer ID in the customer information 162 corresponding to the customer ID in the customer list 161 via the input/output circuit 104.

(8) GPU 111, ROM 112, and RAM 113

The RAM 113 includes a semiconductor memory, and provides a work area when the GPU 111 executes a program.

The ROM 112 includes a semiconductor memory. The ROM 112 stores a control program that is a computer program for executing processing in the recognition processing unit 170, and the like.

The GPU 111 is a graphic processor that operates according to a control program stored in the ROM 112.

By the GPU 111 operating according to the control program stored in the ROM 112 using the RAM 113 as a work area, the GPU 111, the ROM 112, and the RAM 113 constitute the recognition processing unit 170.

A neural network or the like is incorporated in the recognition processing unit 170. The neural network or the like incorporated in the recognition processing unit 170 performs its function by the GPU 111 operating according to a control program stored in the ROM 112.

Details of the recognition processing unit 170 will be described later.

### 1.3 Typical Neural Network

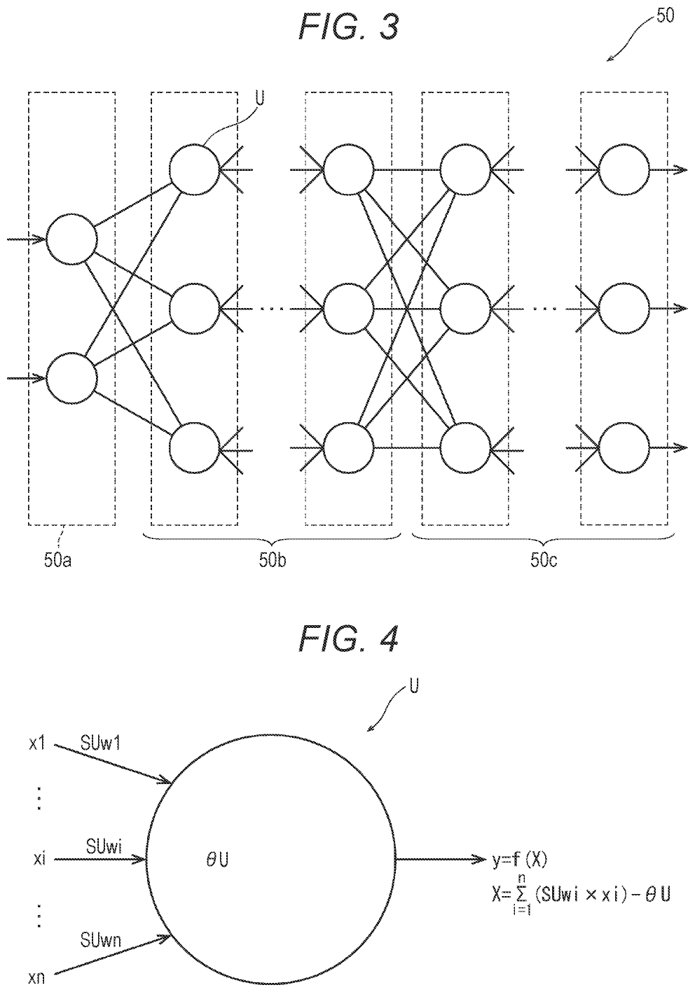

As an example of a typical neural network, a neural network 50 illustrated in FIG. 3 will be described.

(1) Structure of Neural Network 50

As illustrated in this drawing, the neural network 50 is a hierarchical neural network including an input layer 50a, a feature extraction layer 50b, and a recognition layer 50c.

Here, the neural network is an information processing system that mimics a human neural network. In the neural network 50, an engineering neuron model corresponding to a nerve cell is referred to as a neuron U herein. The input layer 50a, the feature extraction layer 50b, and the recognition layer 50c each include a plurality of neurons U.

The input layer 50a usually includes one layer. Each neuron U of the input layer 50a receives, for example, a pixel value of each pixel constituting one frame image. The received image value is directly output from each neuron U of the input layer 50a to the feature extraction layer 50b.

The feature extraction layer 50b extracts a feature from data (all pixel values constituting one frame image) received from the input layer 50a, and outputs the feature to the recognition layer 50c. The feature extraction layer 50b extracts, for example, a region in which a person appears from the received frame image by calculation in each neuron U.

The recognition layer 50c performs identification using the feature extracted by the feature extraction layer 50b. The recognition layer 50c identifies the direction of the person, the gender of the person, the clothes of the person, and the like from the region of the person extracted in the feature extraction layer 50b by calculation in each neuron U, for example.

As the neuron U, a multiple-input single-output element is usually used as illustrated in FIG. 4. The signal is transmitted only in one direction, and the input signal xi (i=1, 2, . . . , n) is multiplied by a certain neuron weighting value (SUwi) and input to the neuron U. This neuron weighting value represents the strength of connection between the neuron U and the neuron U arranged in a hierarchical manner. The neuron weighting values can be varied by learning. From the neuron U, a value X obtained by subtracting the neuron threshold value θU from the sum of input values (SUwi×xi) each multiplied by a neuron weighting value SUwi is output after being deformed by a response function f(X). That is, an output value y of the neuron U is expressed by the following mathematical expression.

y=f(X) where X=Σ(SUwi×xi)−θU (i=1,2,3, . . . ,n).

Note that, as the response function, for example, a sigmoid function can be used.

Each neuron U of the input layer 50a usually does not have a sigmoid characteristic or a neuron threshold value. Therefore, the input value appears in the output as it is. On the other hand, each neuron U in the final layer (output layer) of the recognition layer 50c outputs an identification result in the recognition layer 50c.

As a learning algorithm of the neural network 50, for example, an error back propagation method (back propagation) is used in which a neuron weighting value and the like of the recognition layer 50c and a neuron weighting value and the like of the feature extraction layer 50b are sequentially changed using a steepest descent method so that a square error between a value (data) indicating a correct answer and an output value (data) from the recognition layer 50c is minimized.

(2) Training Process

A training process in the neural network 50 will be described.

The training process is a process of preforming preliminary learning of the neural network 50. In the training process, the preliminary learning of the neural network 50 is performed using image data (frame image) with a correct answer (supervised and annotated) obtained in advance.

FIG. 5 schematically illustrates a propagation model of data at the time of preliminary learning.

The image data is input to the input layer 50a of the neural network 50 for each frame image, and is output from the input layer 50a to the feature extraction layer 50b. In each neuron U of the feature extraction layer 50b, an operation with a neuron weighting value is performed on the input data. By this calculation, in the feature extraction layer 50b, a feature (for example, a region of a person) is extracted from the input data, and data indicating the extracted feature is output to the recognition layer 50c (step S51).

In each neuron U of the recognition layer 50c, an operation with a neuron weighting value for input data is performed (step S52). Thus, identification (for example, identification of a person) based on the above feature is performed. Data indicating an identification result is output from the recognition layer 50c.

The output value (data) of the recognition layer 50c is compared with a value indicating a correct answer, and these errors (losses) are calculated (step S53). The neuron weighting value and the like of the recognition layer 50c and the neuron weighting value and the like of the feature extraction layer 50b are sequentially changed so as to reduce this error (back propagation) (step S54). Thus, the recognition layer 50c and the feature extraction layer 50b are learned.

(3) Practical Recognition Process

A practical recognition process in the neural network 50 will be described.

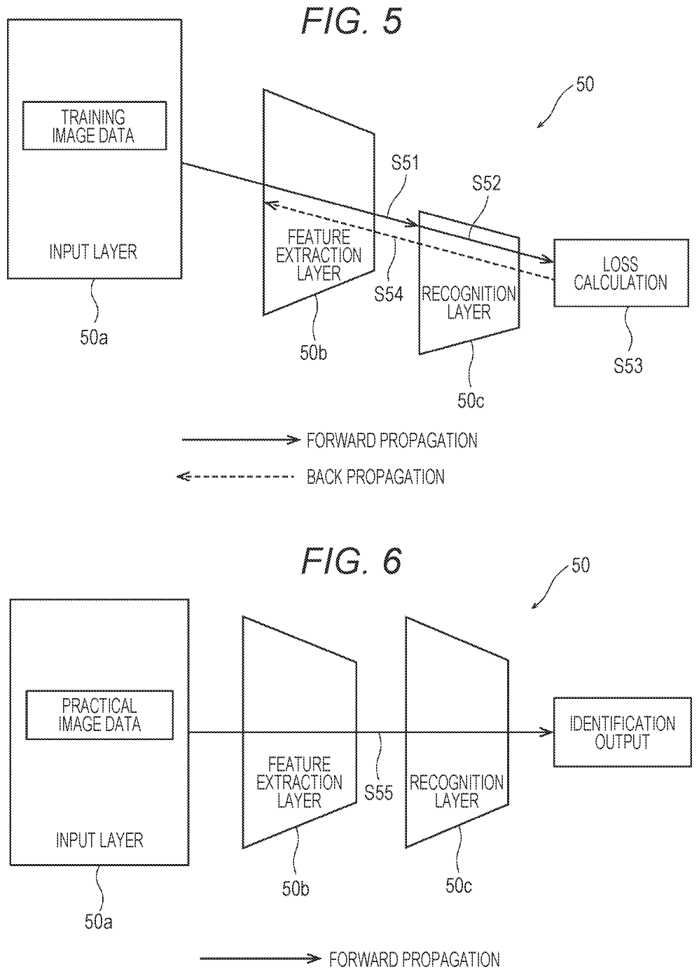

FIG. 6 illustrates a propagation model of data when recognition (for example, recognition of the gender of a person) is actually performed using data obtained on site as an input using the neural network 50 learned by the above training process.

In the practical recognition process in the neural network 50, feature extraction and recognition are performed using the learned feature extraction layer 50b and the learned recognition layer 50c (step S55).

### 1.4 Recognition Processing Unit 170

As illustrated in FIGS. 2 and 7, the recognition processing unit 170 includes a skeleton detector 171, a posture determiner 172, the customer service determiner 173, a number calculator 174, an entry and exit detection unit 175, and a control unit 176.

The recognition processing unit 170 receives an instruction to start the recognition processing from the integrated control unit 122. Upon receiving an instruction to start the recognition processing, the recognition processing unit 170 starts the recognition processing.

(1) Skeleton Detector 171

The skeleton detector 171 (detector) detects, by using a received moving image (image), point information indicating a skeleton point on the skeleton of the customer or an end point on the contour of the customer reflected in the moving image as described below.

Upon receiving an instruction to start the recognition processing from the integrated control unit 122, the skeleton detector 171 reads the moving image 132 including the frame images 132a, 132b, 132c, . . . from the storage device 115 via the input/output circuit 114. Here, the unit of the frame image 132a, the unit of the frame image 132b, the unit of the frame image 132c, . . . are referred to as frames, and as illustrated in FIG. 7, the respective frames are indicated as F1, F2, and F3.

Here, as illustrated in FIG. 7, as an example, the frame image 132a includes objects representing a person a, a person b, and a person c. Note that images of persons (customers) included in the frame images 132a, 132b, 132c, . . . are referred to as objects.

The skeleton detector 171 detects and recognizes an object of a person (customer) from the frame images 132a, 132b, 132c, . . . constituting the moving image 132 by processing by the neural network.

Note that the frame image also includes an object of a body that is not a person (desk, furniture, or the like). Since these objects do not move, they can be distinguished from a person. Further, the frame image also includes an object of the customer and an object of the staff of the store 8 as the object of the person. Here, if the staff of the store 8 wears a uniform, by learning the uniform of the staff, it is possible to distinguish the object of the customer and the object of the staff and recognize the object of the customer.

Further, the skeleton detector 171 detects point information indicating skeleton points joint points) on the skeleton of an object such as a person using OpenPose (see Zhe Cao, Gines Hidalgo, Tomas Simon, Shih-En Wei, Yaser Sheikh, “OpenPose: Realtime Multi-Person 2D Pose Estimation using Part Affinity Fields”, the Internet <https://arxiv.org/abs/1812.08008>) from the frame images 132a, 132b, 132c, . . . constituting the moving image 132 by processing by the neural network. Here, the skeleton point is expressed by a coordinate value (X coordinate value. Y coordinate value) of a position where the skeleton point exists in the frame image and a coordinate value (time t or frame number t indicating a frame image) on the time axis corresponding to the frame image in which the skeleton point exists.

Note that the skeleton detector 171 may detect point information indicating an end point (vertex) on the contour of the object of the person using YOLO (Joseph Redmon, Santosh Divvala, Ross Girshick, Ali Farhadi, “You Only Look Once: Unified, Real-Time Object Detection”, Computer Vision and Pattern Recognition (CVPR) 2016) from the frame images 132a, 132b, 132c, . . . constituting the moving image 132 by processing by the neural network. Here, the end point is also expressed by a coordinate value (X coordinate value. Y coordinate value) of a position where the end point exists in the frame image and a coordinate value (time t or frame number t indicating a frame image) on the time axis corresponding to the frame image in which the end point exists.

Further, the point information further includes a unique identifier (object ID) of the object, that is, a feature vector indicating the customer ID.

Further, each frame point cloud further includes the time (year, month, day, hour, minute, and second) at which the corresponding frame image is generated.

The skeleton detector 171 generates, from the moving image 132 including the frame images 132a, 132b, 132c, . . . the point cloud data 133 including a plurality of pieces of detected point information (indicating a plurality of skeleton points or a plurality of end points).

Note that, in order to facilitate understanding of association between the moving image 132 and the point cloud data 133, in FIG. 7, the point cloud data 133 is expressed so as to include the frame point clouds 133a, 133b, 133c, . . . corresponding to the frame images 132a, 132b, 132c, . . . , respectively, included in the moving image 132.

However, as described above, the point information includes the coordinate value (X coordinate value, Y coordinate value) of the position where the joint point or the end point exists in the frame image and the coordinate value (time t) on the time axis corresponding to the frame image in which the joint point or the end point exists, and there is no point cloud in the data format such as the frame point clouds 133a, 133b, 133c, . . . illustrated in FIG. 7, and thus it is necessary to pay attention. Hereinafter, a similar expression method is employed.

The skeleton detector 171 writes the point cloud data 133 in the storage device 115 via the input/output circuit 114.

Further, as illustrated in FIG. 7, as an example, the frame point cloud 133a includes a person point cloud a, a person point cloud b, and a person point cloud c detected from the person a, the person b, and the person c, respectively.

Here, since the frame point clouds 133a, 133b, 133c, . . . are generated from the frame images 132a, 132b, 132c, . . . , respectively, each of a unit of the frame point cloud 133a, a unit of the frame point cloud 133b, a unit of the frame point cloud 133c, . . . is referred to as a frame. Further, in the following description, a unit of a feature amount generated corresponding to the frame point clouds 133a, 133b, 133c, . . . is also referred to as a frame.

Further, the skeleton detector 171 tracks the behavior of one person by associating a plurality of objects representing the same person among objects representing a plurality of persons captured in a plurality of frame images obtained at different times by processing by the neural network.

Specifically, the skeleton detector 171 detects objects of a plurality of persons from a plurality of frame images using a neural network, and recognizes and extracts an attribute or a feature amount such as gender, clothes, and age of the persons from each of the detected objects of the plurality of persons.

The skeleton detector 171 determines whether or not the attribute or the feature amount extracted from the first object detected from the first frame image matches the attribute or the feature amount extracted from the second object detected from the second frame image. When they match, it is conceivable that the first object and the second object represent the same person, and thus the skeleton detector 171 has been able to track the behavior of the person.

For example, the skeleton detector 171 applies DeepSort (Nicolai Wojke, Alex Bewley, Dietrich Paulus. “SIMPLE ONLINE AND REALTIME TRACKING WITH A DEEP ASSOCIATION METRIC”, 21 Mar. 2017, the internet <https://arxiv.org/pdf/1703.07402.pdf>) and uses detected skeleton points or end points to specify objects of the same person represented in a plurality of different frame images, thereby tracking the objects of the person.

In this manner, the same object ID is assigned to objects of the same person obtained by the tracking.

Further, the skeleton detector 171 may determine which of the ranges indicated by the range coordinate values of the areas (area 4a and area 4b) stored in the storage device 115 the coordinate values (X coordinate value and Y coordinate value) of the position of the detected point information are present within. Thus, the skeleton detector 171 estimates in which area the detected object exists. The skeleton detector 171 may include the correspondence relationship between the detected object and the area where the object exists in the frame point cloud corresponding to the detected object, and output the frame point cloud.

(2) Posture Determiner 172

The posture determiner 172 (posture determiner) determines the posture of the customer using the point information detected by the skeleton detector 171 as follows.

The posture determiner 172 reads the point cloud data 133 from the storage device 115 via the input/output circuit 114.

The posture determiner 172 performs processing by the neural network on the read point cloud data 133 to determine whether the posture of an object in each frame point cloud included in the point cloud data 133 is the posture 1, the posture 2, the posture 3, the posture 4, or another posture.

Here, as described above, the neural network performs preliminary learning using a large number of pieces of data with correct answer (supervised, annotated) obtained in advance (person point cloud).

Here, each person point cloud with a correct answer used for preliminary learning is a set of joint points or end points extracted from the image of the object of the person as described above. Posture data indicating that the posture is the posture 1 is assigned to a plurality of person point clouds as a correct answer. Further, posture data indicating that the posture is the posture 2 is assigned to another plurality of person point clouds as a correct answer. Further, posture data indicating that the posture is the posture 3 is assigned to another plurality of person point clouds as a correct answer. The same applies to the other plurality of person point clouds.

As described above, since the posture determiner 172, which is a neural network, learns the posture 1, the posture 2, the posture 3, the posture 4, and the like of the person, when the point cloud data 133 is obtained as the actual data, it is possible to stochastically estimate the possibility that the object in each frame point cloud included in the point cloud data 133 is the posture 1, the posture 2, the posture 3, the posture 4, and other postures. That is, the posture determiner 172 outputs probability values (values between 0.0 and 1.0) that are the posture 1, the posture 2, the posture 3, the posture 4, and the like.

As described above, the posture 1 indicates that the object is, for example, in a posture in which a person is standing upright and is operating the MFP with the right hand. Further, the posture 2 indicates that the object is, for example, in a posture in which a person is standing upright and holds his or her head with both hands. The posture 3 indicates that the object is, for example, in a posture in which a person is standing upright and one hand is raised above the shoulder. The posture 4 indicates that the object is, for example, in a posture in which a person is standing upright and one hand is placed on the chin.

Here, the posture 1 is a posture that customer service is not necessary. On the other hand, the posture 2 to the posture 4 are postures that customer service is necessary.

For example, the posture determiner 172 determines whether the posture of the customer is a posture in which his or her hand is placed on the chin or the posture of the customer is a posture in which his or her head is held by hands.

As illustrated in FIGS. 7 and 9, the posture determiner 172 generates the posture list 141 including the posture data 141a, 141b, 141c, . . . including probabilities of being in the posture 1, the posture 2, the posture 3, and the posture 4 as values between 0.0 and 1.0 corresponding to each of the frame point clouds 133a, 133b, 133c, . . . , and writes the generated posture list 141 in the storage device 115 via the input/output circuit 114.

(3) Customer Service Determiner 173

The customer service determiner 173 (customer service determiner) determines whether customer service is necessary for each customer on the basis of the received moving image (image) as described below. Further, the customer service determiner 173 determines whether customer service is necessary for the customer by using the posture determined by the posture determiner 172.

The customer service determiner 173 reads the posture list 141 from the storage device 115 via the input/output circuit 114.

The customer service determiner 173 determines whether customer service is necessary using the values of the posture 1, the posture 2, the posture 3, and the posture 4 for each object ID (that is, for each customer) for each of the posture data 141a, 141b, 141c, . . . included in the posture list 141.

For example, since the posture information corresponding to the object ID “IDa” in the posture data 141a includes the posture 1 “0.90”, the posture 2 “0.01”, the posture 3 “0.01”, and the posture 4 “0.02” (see FIG. 9), the customer service determiner 173 employs the posture 1 having the highest value “0.90” among these values, and since the posture 1 is a posture that customer service is not necessary, 1−0.90=0.10 is determined as the value of customer service necessity.

Further, for example, since the posture information corresponding to the object ID “IDb” in the posture data 141a includes the posture 1 “0.02”, the posture 2 “0.80”, the posture 3 “0.02”, and the posture 4 “0.01” (see FIG. 9), the customer service determiner 173 employs the posture 2 having the highest value “0.80” among these values, and determines 0.80 as the value of customer service necessity since the posture 2 is a posture that customer service is necessary.

Further, for example, since the posture information corresponding to the object ID “IDc” in the posture data 141a includes the posture 1 “0.03”, the posture 2 “0.01”, the posture 3 “0.75”, and the posture 4 “0.01” (see FIG. 9), the customer service determiner 173 employs the posture 3 having the highest value “0.75” among these values, and determines 0.75 as the value of customer service necessity since the posture 3 is a posture that customer service is necessary.

For example, when it is determined that the posture of the customer is the posture in which his or her hand is placed on the chin, or when it is determined that the posture of the customer is the posture in which his or her head is held by hands, the customer service determiner 173 determines that the customer service for the customer is necessary.

The customer service determiner 173 generates object information including the object ID and the determined value of customer service necessity, and writes the object information in the object data via the input/output circuit 114.

In this manner, as illustrated in FIGS. 7 and 10, the customer service determiner 173 writes the object list 135 including the object data 135a, 135b, 135c, . . . in the storage device 115.

(4) Number Calculator 174

The number calculator 174 reads the point cloud data 133 from the storage device 115 via the input/output circuit 114.

As described above, the point information constituting the point cloud data 133 includes the unique identifier (object ID) of the object, that is, the feature vector indicating the customer ID.

The number calculator 174 calculates the number of types of object IDs included in the frame point cloud for each frame point cloud with respect to the read point cloud data 133. That is, the number calculator 174 calculates the number of objects included in each frame point cloud included in the point cloud data 133.

In this manner, the number calculator 174 writes the number list 155 including the numbers of objects 155a, 155b, 155c, . . . to the storage device 115 corresponding to each of the frame point clouds 133a, 133b, 133c, . . . via the input/output circuit 114.

In addition, the number calculator 174 may extract, from each of the frame point clouds 133a, 133b. 133c, . . . a correspondence relationship between an object and an area in which the object exists. Next, the number calculator 174 calculates the number of objects for each area in the same manner as described above using the extracted correspondence relationship between objects and areas.

(5) Entry and Exit Detection Unit 175

The entry and exit detection unit 175 stores in advance the position of a region (entrance region) where an entrance 2 exists in the frame image generated by image capturing by the camera 5.

The entry and exit detection unit 175 reads the point cloud data 133 from the storage device 115 via the input/output circuit 114.

The entry and exit detection unit 175 determines whether or not one object (customer) exists in the entrance region using each piece of frame point cloud data included in the read point cloud data 133.

When it is determined that one object exists in the entrance region, the entry and exit detection unit 175 detects a change in size of the object by using a plurality of pieces of frame point cloud data before (temporally before) the frame point cloud data and a plurality of pieces of frame point cloud data after (temporally after) the frame point cloud data. When it is detected that the size of the object changes to increase, the entry and exit detection unit 175 determines that the object is about to enter the store 8. On the other hand, when it is detected that the size of the object is changed to be small, the entry and exit detection unit 175 determines that the object is about to exit from the store 8.

When it is determined at one point that the object is about to enter the store from the entrance 2, the entry and exit detection unit 175 generates entry and exit information including the object ID, a flag “1” indicating entrance, and the time of entrance. Further, when it is determined that a plurality of objects is about to enter the store from the entrance 2 at a time point, the entry and exit detection unit 175 generates a plurality of pieces of entry and exit information (see FIG. 12).

Further, when it is determined that the object is about to exit from the entrance 2 at the time point, the entry and exit detection unit 175 generates entry and exit information including the object ID, the flag “2” indicating exit, and the time of exit. Further, when it is determined that a plurality of objects is about to exit from the entrance 2 at a time point, the entry and exit detection unit 175 generates a plurality of pieces of entry and exit information (see FIG. 12).

When it is not determined that the object is about to enter the store from the entrance 2, the entry and exit detection unit 175 does not generate the entry and exit information. Further, when it is not determined that the object is about to exit from the entrance 2, the entry and exit detection unit 175 does not generate the entry and exit information.

In this manner, the entry and exit detection unit 175 generates one piece of entry and exit data including one piece of generated entry and exit information at one point, or generates one piece of entry and exit data including a plurality of pieces of the entry and exit information at one point.

Every time one entry and exit data is generated, the entry and exit detection unit 175 notifies the control unit 176 that the entry and exit data has been generated.

Further, the entry and exit detection unit 175 writes the generated entry and exit information in the entry and exit data in the entry and exit list 151 via the input/output circuit 114.

In this manner, as illustrated in FIG. 7 as an example, the entry and exit list 151 including the entry and exit data 151a, 151b, 151c, . . . is written in the storage device 115.

(6) Control Unit 176

The control unit 176 integrally controls the skeleton detector 171, the posture determiner 172, the customer service determiner 173, the number calculator 174, and the entry and exit detection unit 175.

The control unit 176 receives a notification that the entry and exit data is generated from the entry and exit detection unit 175. Upon receiving this notification, the control unit 176 reads the generated entry and exit data from the storage device 115 via the input/output circuit 114. Next, the control unit 176 outputs the read entry and exit data to the integrated control unit 122 via the bus B2 and the bus B1.

### 1.5 Operation of Customer Service Management Apparatus 10

An operation in the customer service management apparatus 10 will be described.

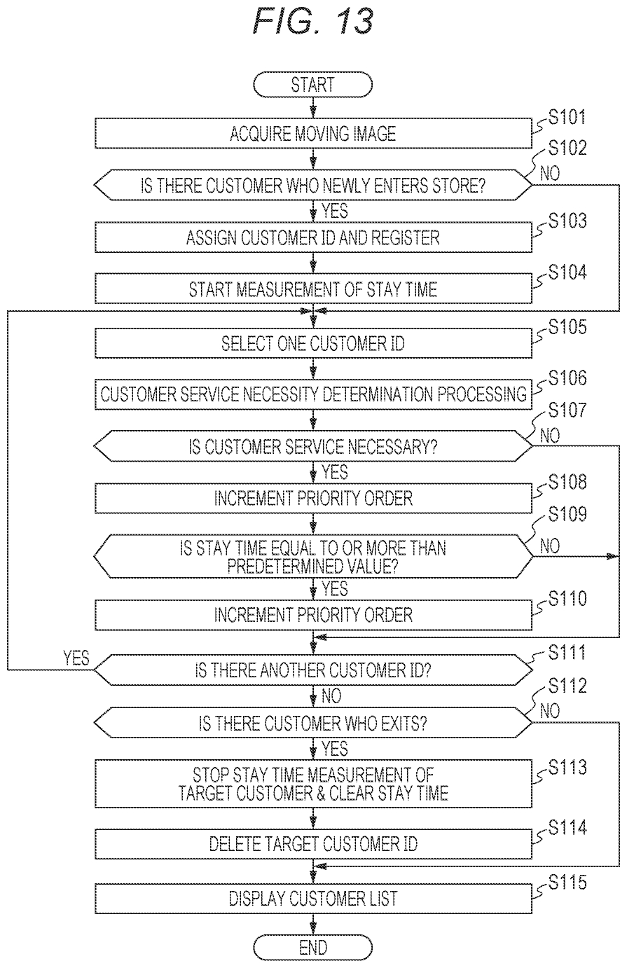

(1) An operation of the customer service management apparatus 10 mainly in the main control unit 121 will be described with reference to a flowchart illustrated in FIG. 13.

The procedure illustrated in this flowchart is executed periodically (for example, once every 5 seconds).

The input circuit 107 acquires the moving image from the camera 5, and the integrated control unit 122 outputs an instruction to start the recognition processing to the recognition processing unit 170 (step S101). The customer list update unit 123 determines whether or not there is a customer who enters the store 8 using the entry and exit data 151a (step S102).

When it is determined that there is no customer who newly enters the store 8 at the entrance 2 of the store 8 (“NO” in step S102), the integrated control unit 122 shifts the control to step S105.

When it is determined that there is a customer who enters the store at the entrance 2 (“YES” in step S102), the customer list update unit 123 assigns the object ID as the customer ID, and registers the customer ID in the customer list 161 (step S103). Next, the time calculation unit 124 starts measurement of the stay time of the newly entered customer (step S104).

The integrated control unit 122 selects one customer ID from the customer list 161 (step S105).

The customer list update unit 123 determines whether the customer service necessity 165 included in the customer information 162 is “necessary” or “unnecessary” with respect to the customer information 162 including the selected customer ID (step S106).

When it is determined that the customer service necessity 165 included in the customer information 162 is “unnecessary” (“NO” in step S107), the integrated control unit 122 shifts the control to step S111 without performing the processes of steps S108 to S110.

When it is determined that the customer service necessity 165 included in the customer information 162 is “necessary” (“YES” in step S107), the customer list update unit 123 increases the priority order of the customer ID by one (step S108).

Next, the customer list update unit 123 determines whether the determination result 167 is less than a predetermined value or equal to or more than a predetermined value for the customer information 162 including the selected customer ID. That is, the customer list update unit 123 determines whether the stay time of the customer is less than the predetermined time or equal to or longer than the predetermined time (step S109).

When it is determined that the determination result 167 is less than the predetermined value (“NO” in step S109), the customer list update unit 123 does not perform the process of step S110.

On the other hand, when it is determined that the determination result 167 is equal to or more than the predetermined value (“YES” in step S109), the customer list update unit 123 increases the priority order of the customer ID by one (step S110).

Next, the integrated control unit 122 determines whether or not there is another customer ID for which processing has not been completed (step S111).

When it is determined that there is another customer ID for which the processing has not been completed (“YES” in step S111), the integrated control unit 122 shifts the control to step S105 and repeats the processing.

When it is determined that there is no other customer ID for which the processing has not been completed (“NO” in step S111), the customer list update unit 123 determines whether or not there is a customer who exits from the store 8 using the entry and exit data 151a (step S112).

When it is determined that there is no customer who exits from the store 8 (“NO” in step S112), the integrated control unit 122 shifts the control to step S115.

When it is determined that there is a customer who exits from store 8 (“YES” in step S112), the time calculation unit 124 stops measurement of the stay time of the customer who exits, and clears the stay time to “0” (step S113). Next, the customer list update unit 123 deletes the customer ID by deleting the customer information including the customer ID for identifying the exiting customer from the customer list 161 (step S114).

Next, the integrated control unit 122 controls the customer list update unit 123 to read the associated customer list 161 and staff ID from the storage device 105, output the read customer list 161 and staff ID to the output circuit 108, and cause the customer list 161 and the staff ID to be displayed on the monitor 6 (step S115).

Looking at the customer list 161 and the staff ID displayed on the monitor 6, the staff identified by the staff ID performs customer service for the customer identified by the customer ID according to the priority order indicated in the customer list 161.

As described above, the operation of mainly the main control unit 121 of the customer service management apparatus 10 is ended.

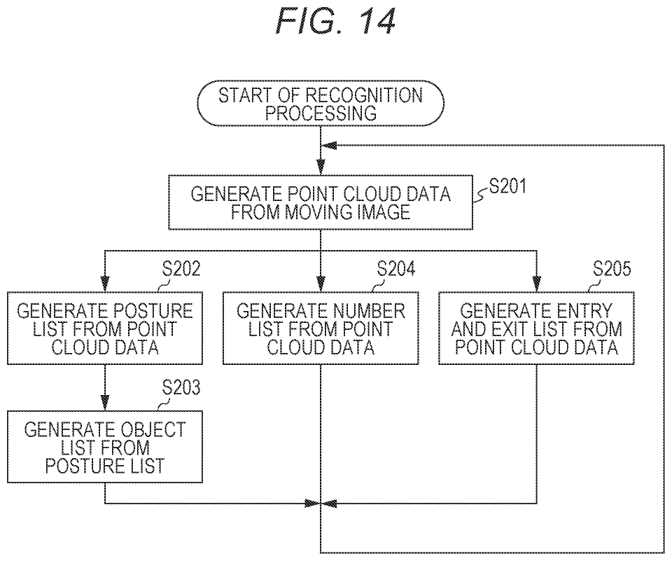

(2) An operation of the recognition processing unit 170 of the customer service management apparatus 10 will be described with reference to a flowchart in FIG. 14.

In step S101 of the flowchart illustrated in FIG. 13, the integrated control unit 122 outputs an instruction to start the recognition processing to the recognition processing unit 170. Upon receiving the instruction to start the recognition processing, the recognition processing unit 170 operates as follows.

The skeleton detector 171 generates the point cloud data 133 using the moving image 132 (step S201).

Next, the posture determiner 172 generates the posture list 141 using the point cloud data 133 (step S202).

Next, the customer service determiner 173 generates the object list 135 using the posture list 141. The object list 135 is output to the main control unit 121 (step S203).

Next, the control unit 176 shifts the control to step S201 and repeats the processing.

Further, when the point cloud data 133 is generated, the number calculator 174 generates the number list 155 using the point cloud data 133. The number list 155 is output to the main control unit 121 (step S204).

Next, the control unit 176 shifts the control to step S201 and repeats the processing.

Further, when the point cloud data 133 is generated, the entry and exit detection unit 175 generates the entry and exit list 151 using the point cloud data 133. The entry and exit list 151 is output to the main control unit 121 (step S205).

Next, the control unit 176 shifts the control to step S201 and repeats the processing.

### 1.6 Specific Example

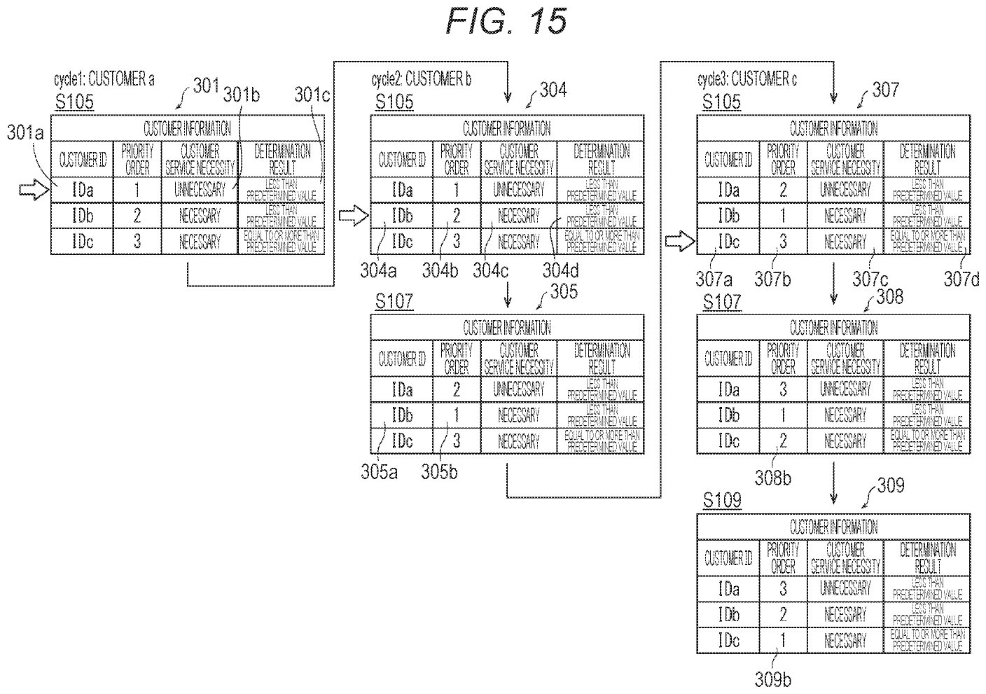

How the priority order in the customer list changes in the processes of steps S105 to Sill of the flowchart illustrated in FIG. 13 will be described using the specific example illustrated in FIG. 15.

In each customer list illustrated in FIG. 15, it is assumed that three customers of a customer a, a customer b, and a customer c stay in the store 8. Here, it is assumed that customer IDs of the customer a, the customer b, and the customer c are “IDa”, “IDb”, and “IDc”, respectively. Further, in order to simplify the description, the “stay time” is omitted from the customer list 161 illustrated in FIG. 8 in each customer list illustrated in FIG. 15.

As illustrated in a customer list 301 of FIG. 15, it is assumed that customer a does not need customer service and the stay time of customer a is less than a predetermined time. It is assumed that customer b needs customer service, and the stay time of customer b is less than a predetermined time. It is assumed that customer c needs customer service, and the stay time of customer c is equal to or longer than a predetermined time. Further, it is assumed that the priority orders of the customer a, the customer b, and the customer c are “1”, “2”, and “3”, respectively, before the processes of steps S105 to S111 of the flowchart illustrated in FIG. 13 are performed.

In step S105 of the first cycle of repetition of steps S105 to S111, the customer ID (301a) “IDa” of the customer list 301 is selected. Since the customer service necessity 301b with the customer ID (301a) “IDa” is “unnecessary”, it is determined in step S107 that the customer service is unnecessary, and increase of the priority order in step S108 is not executed. Further, since the determination result 301c of the customer ID (301a) “IDa” is “less than predetermined value”, the priority order is not increased in step S110 without passing through step S109.

As a result, there is no change in the content of the customer list 301 at the time when the first cycle of repetition from steps S105 to S111 ends.

Next, in step S105 of the second cycle of repetition from steps S105 to S111, the customer ID (304a) “IDb” illustrated in a customer list 304 are selected. Since the customer service necessity 304c of the customer ID (304a) “IDb” is “necessary”, it is determined that the customer service is necessary in step S107, and the priority order in step S108 is increased. As a result, the priority order 304b “2” in the customer list 304 is the priority order 305b “1” as illustrated in a customer list 305. Further, since the determination result 304d of the customer ID (304a) “IDb” is “less than predetermined value”, the priority order is not increased in step S110.

As a result, the priority order 304b “2” of the customer ID (304a) “IDb” of the customer list 304 before passing through the process of step S107 is increased to the priority order 305b “1” in the customer list 305 at the point of time when the repetitive second cycle from steps S105 to S111 ends.

Next, in step S105 of the third cycle of repetition of steps S105 to S111, the customer ID (307a) “IDc” illustrated in a customer list 307 is selected. Since the customer service necessity 307c of the customer ID (307a) “IDc” is “necessary”, it is determined that the customer service is necessary in step S107, and the priority order in step S108 is increased. As a result, the priority order 307b “3” in the customer list 307 is the priority order 308b “2” as illustrated in a customer list 308. Further, since the determination result 307d of the customer ID (307a) “IDc” is “equal to or more than predetermined value”, the priority order is increased in step S110. As a result the priority order 308b “2” in a customer list 308 is the priority order 309b “1” as illustrated in a customer list 309.

As a result the priority order 307b “3” of the customer ID (307a) “Dc” of the customer list 307 before passing through the process of step S107 is increased to the priority order 309b “1” in the customer list 309 at the time point the third cycle of repetition from steps S105 to S111 ends.

### 1.7 Summary

As described above, according to the first embodiment, a customer for which it is determined that customer service is necessary is discriminated in a store using a video generated by image-capturing by a camera, an order of the customer service is determined for a plurality of customers for which it is determined that customer service is necessary, and customer service is provided to the customer who needs customer service according to the determined order of the customer service. Thus, an excellent effect that it is possible to meet the desires of customers who need customer service can be obtained.

### 1.8 Modification

(1) In the first embodiment, the recognition processing unit 170 uses processing by a neural network. However, the embodiment is not limited to this.

For example, without using the processing by the neural network, for example, when the position coordinates of the wrist of a person approaches the position coordinates of his or her head, that is, when the difference between the position coordinates of the wrist of the person and the position coordinates of the head is less than a predetermined threshold value, the customer service determiner 173 may determine that the person is performing a head scratching action or a head holding action.

Further, for example, when the position coordinates of one of the right and left wrists of a person are located above the position coordinates of one of the right and left shoulders, the customer service determiner 173 may determine that the person is in a state of raising a hand.

In order to know a change in the position coordinates of joint points of a person, it is only required to calculate the absolute value of the amount of change between the position coordinates of the joint points of the person in a first frame image and the position coordinates of the same joint points of the same person in a second frame image. In addition, the square root of the sum of squares of differences between the position coordinates of the joint points of the person in the first frame image and the position coordinates of the joint points of the same person in the second frame image may be calculated.

(2) When the same action is detected for a predetermined time (for example, 3 seconds) or more or when the same action is detected a predetermined number of times (for example, three times) or more after an action of scratching the head, an action of holding the head, an action of raising the hand, or the like of himself or herself from the moving image, the customer service determiner 173 may recognize that the customer has performed the action of scratching the head, the action of holding the head, the action of raising the hand, or the like of himself or herself, and determine that the customer is looking for a staff to ask for customer service.

(3) The customer service determiner 173 may determine skill level of an operation from the speed at which the joint points or the like of the customer (object) detected by the skeleton detector 171 move, and determine whether customer service is necessary. That is, when the speed at which the joint points or the like of the object move is less than a predetermined speed threshold value, the customer service determiner 173 determines that the skill level of the customer in operating the MFP is low. On the other hand, when the speed at which the joint point or the like of the object moves is equal to or more than the predetermined speed threshold value, the customer service determiner 173 determines that the skill level of the customer in operating the MFP is high. When it is determined that the skill level of the customer in operating the MFP is low, the customer service determiner 173 determines that customer service for the customer is necessary. On the other hand, when the customer service determiner 173 determines that the skill level of the customer in operating the MFP is high, the customer service determiner determines that the customer service for the customer is not necessary.

(4) The customer service determiner 173 uses the point cloud data 133 to determine whether the customer is in trouble. That is, the customer service determiner 173 may determine whether or not the customer is in trouble by comparing a model image (point cloud data) that is stored in advance of a posture in trouble with the point cloud data 133, or the like.

(5) In the first embodiment, a case where an MFP is disposed in the store 8 has been described.

However, the embodiment is not limited to this example.

The store 8 may be a bank, and a plurality of ATMs may be arranged in the store 8 instead of the plurality of MFPs. The customer performs an operation on the ATM instead of the operation on the MFP of the first embodiment. Also in this case, the same functions as in the first embodiment can be achieved, and the same effects can be achieved.

In addition, the store 8 may be a store that sells clothes, and a plurality of clothes may be displayed in the store 8 for sale instead of the MFP of the first embodiment. Instead of operating the MFP of the first embodiment, the customer approaches the displayed clothes, looks at clothes, picks up clothes, and selects his or her favorite clothes. Also in this case, the same functions as in the first embodiment can be achieved, and the same effects can be achieved.

In addition, the store 8 may be an electric appliance store that sells home electric appliances, and home electric appliances such as refrigerators, air conditioners, television receivers, and personal computers may be displayed in the store 8 for sale instead of the MFP of the first embodiment. The inside of the store 8 may be divided into a plurality of areas (sub regions). Refrigerators may be displayed in a first area, air conditioners may be displayed in a second area, television receivers may be displayed in a third area, and personal computers may be displayed in a fourth area. Instead of operating the MFP of the first embodiment, a customer approaches an exhibited home electric appliance in each area, looks at the home electric appliance, picks up the home electric appliance, operates the home electric appliance, and selects his or her favorite home electric appliance. Also in this case, the same functions as in the first embodiment can be achieved, and the same effects can be achieved.

(6) The customer list update unit 123 may determine to increase the priority order as described below.

(a) The time calculation unit 124 may measure an elapsed time from a point of time when it is determined that customer service is necessary for the customer instead of measuring the stay time from the time when the customer enters the store. The customer list update unit 123 may increase the priority order of the customer when the elapsed time for the customer exceeds a predetermined elapsed time threshold value (for example, five minutes).

That is, for each of the plurality of customers for which it is determined that customer service is necessary, the time calculation unit 124 (time calculator) may calculate a time during which the customer for which it is determined that customer service is necessary stays in the store 8 from the time point when the customer service determiner 173 determines that customer service is necessary. In addition, the customer list update unit 123 may determine the order of customer service for a plurality of customers for which it is determined that customer service is necessary by the customer service determiner 173 using the calculated time.

In this case, the customer list update unit 123 may give priority in the order of customer service to a customer staying in the store 8 for a time longer than a predetermined threshold value among a plurality of customers for which it is determined that customer service is necessary. Here, the predetermined threshold value is, for example, 10 minutes.

(b) The region in the store 8 may include a plurality of areas (a plurality of sub regions).

In a case where the inside of the store 8 is divided into a plurality of areas as in the case of the above-described home appliance store, the number calculator 174 may calculate the number of objects (the number of customers) staying in the area for each area (for each sub region) on the basis of a received moving image.

The customer list update unit 123 (determiner) may determine the order of the customer service in the sub region using the number of customers calculated for each area.

Further, the customer list update unit 123 determines whether or not the number of customers calculated for each area is equal to or more than a predetermined threshold value for the number of customers (which is determined depending on the size of the area, the number of household electric appliances displayed in the area, and the like and is, for example, 20 persons). When it is determined that the calculated number of customers is equal to or more than the predetermined customer number threshold value, the customer list update unit 123 may increase the order of customer service for all customers staying in the area by one.

When customers concentrate on one area, customer service can be improved by preferentially serving the customer staying in the area where the customers concentrate over other areas. In this case, for example, the customer list update unit 123 may create a customer list for each area.

(6) In the first embodiment, a process of increasing the priority order is performed for a customer who needs customer service. However, the embodiment is not limited to this.

In the customer list, an assistance level may be provided for each customer ID. The assistance level takes a score of, for example, 1, 2, 3, . . . , or the like. The score of the assistance level is made variable according to the determination result by the customer service determiner 173. When it is determined that guidance in the store 8 is necessary for a customer who has entered the store 8, the score of the assistance level is set to two points. When it is determined that the operation explanation is necessary for a customer operating the MPF, the score of the assistance level is set to 1 point. When a customer needs to call a staff in charge of checkout at the checkout counter, the score of the assistance level is set to 1 point.

A customer for which the assistance level set in this manner is higher may be preferentially provided with assistance.

In addition, depending on the stay time of a customer, for example, only two points may be added to the assistance level for a customer staying for a predetermined stay time threshold value or longer.

In addition, the priority order of the customer list may be determined according to the assistance level after comprehensively scoring the assistance level as described above.

(7) The customer list update unit 123 (determiner) may give priority in the order of customer service to a customer staying in the store 8 for a time longer than a predetermined threshold value among a plurality of customers for which it is determined that customer service is necessary. Here, the predetermined threshold value is, for example, 10 minutes. Thus, it is possible to improve the customer service to such a customer.

(8) The region in the store 8 includes a plurality of sub regions, and a plurality of customers may stay in each sub region.

The number calculator 174 may calculate, for each sub region, the number of customers who stay in the sub region and need customer service on the basis of the received moving image.

The time calculation unit 124 may calculate, for each customer who needs customer service, the time during which the customer stays in each sub region from the time point when it is determined that customer service is necessary.

For each sub region, the customer list update unit 123 may determine the order of customer service by giving priority to a customer staying longer than a predetermined threshold value using the calculated time.

### 2. Second Embodiment

### 2.1 Second Embodiment is a Modification of the First Embodiment

Here, differences from the first embodiment will be mainly described.

In the second embodiment, when it is determined that customer service for a customer is necessary, a correspondence relationship between a customer for which it is determined that customer service is necessary and a customer service staff providing customer service is determined as follows.

Here, a plurality of staffs who provide customer service may be arranged in the store 8. In addition, the skill level of customer service may be different for each staff. A correspondence relationship between a customer who needs customer service and a staff providing customer service may be determined on the basis of the skill level of the staff.

In the second embodiment, as an example, it is assumed that there are two staffs a and b having different skill level in the store 8 and performs customer service. Usually, the staff a is in charge of area A (area 4a illustrated in FIG. 1), and the staff b is in charge of area B (area 4b illustrated in FIG. 1). The skill level of customer service of the staff b is higher than that of the staff a.

In addition, it is assumed that the contents of customer service provided by the staff to the customer include a customer service type A “operation method explanation”, a customer service type B “checkout”, and a customer service type C “guidance”. The customer service type A “operation method explanation” is customer service for a customer in need of an operation method unknown in front of the MPF. The customer service type B “checkout” is customer service for a customer who cannot make a payment due to the absence of a reception staff at the reception counter 3. The customer service type C “guidance” is customer service for a customer who does not know where to go in the store 8 at the entrance 2.

The staff a needs a customer service time of two minutes for customer service regarding the operation method explanation, eight minutes for customer service regarding checkout, and 12 minutes for service regarding the guidance. Further, the staff b needs a customer service time of one minute for the customer service regarding the operation method explanation, five minutes for the customer service regarding checkout, and 10 minutes for the customer service regarding the guidance.

In the second embodiment, it is assumed that three customers a, b, and c visit the store and stay. The customer IDs for identifying the customers a, b, and c are “IDa”, “IDb”, and “IDc”, respectively. The customer a needs to use the area A and needs the customer service regarding checkout. The customer b also needs to use the area A and needs the customer service regarding checkout. The customer c uses the area B and needs to serve a customer for guidance.

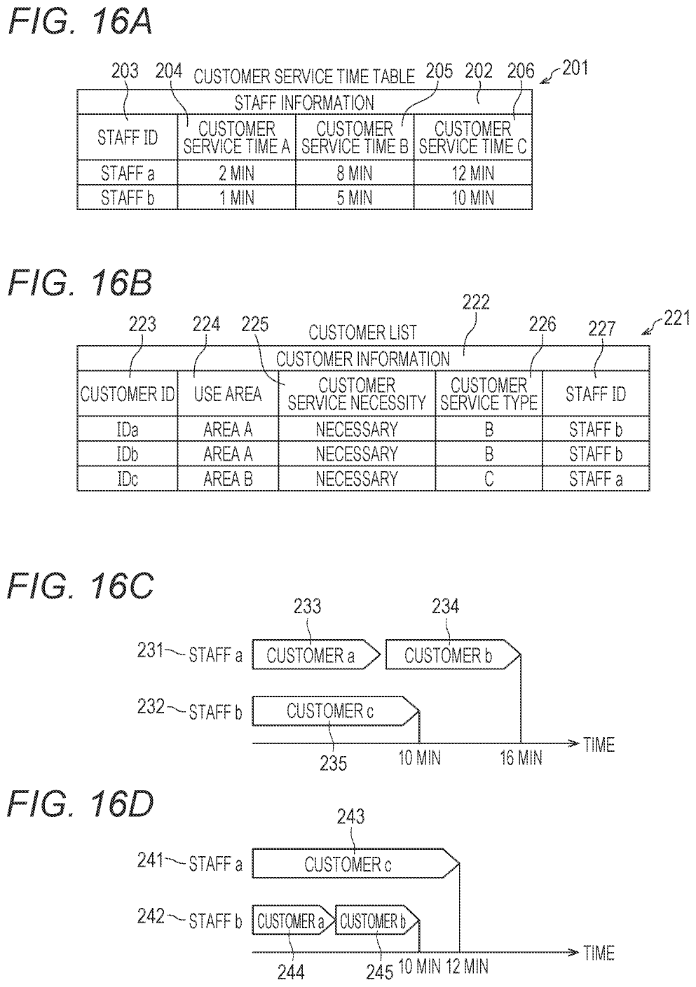

The storage device 105 of the customer service management apparatus 10 further stores a customer service time table 201 illustrated in FIG. 16A. Further, the storage device 105 stores a customer list 221 illustrated in FIG. 16B instead of the customer list 161 illustrated in FIG. 8.

(Customer Service Time Table 201)

As illustrated in FIG. 16B, the customer service time table 201 includes a plurality of pieces of staff information 202. The number of pieces of staff information 202 included in the customer service time table 201 is equal to the total number of staffs of the store 8. Each piece of the staff information 202 corresponds to each staff.

Each piece of the staff information 202 includes a staff ID (203), a customer service time A (204), a customer service time B (205), and a customer service time C (206). Each piece of the staff information 202 may further include a customer service time of another service.

The staff ID (203) is identification information for uniquely identifying the staff.

The customer service time A (204) is a time necessary for the customer service of the customer service type A by the staff.

The customer service time B (205) is a time necessary for the customer service of the customer service type B by the staff.

The customer service time C (206) is a time necessary for the customer service of the customer service type C by the staff.

The customer service time A (204), the customer service time B (205), and the customer service time C (206) by the staff identified by the staff ID (203) “staff a” are “2 minutes”, “8 minutes”, and “12 minutes”, respectively.

Further, the customer service time A (204), the customer service time B (205), and the customer service time C (206) by the staff identified by the staff ID (203) “staff b” are “1 minute”, “5 minutes”, and “10 minutes”, respectively.

(Customer list 221)

As illustrated in FIG. 16B, the customer list 221 includes a plurality of pieces of customer information 222. The number of pieces of customer information 222 included in the customer list 221 is equal to the number of customers who is about to enter the store 8 and stay in the store 8. Each piece of the customer information 222 corresponds to each customer.

The customer information 222 includes a customer ID (223), a use area 224, a customer service necessity 225, a customer service type 226, and a staff ID (227).

The customer ID (223) is identification information for uniquely identifying the customer.

The use area 224 indicates an area where the customer stays. In the example illustrated in FIG. 16B, the use area 224 is “area A” or “area B”.

The customer service necessity 225 indicates whether or not the customer needs customer service.

The customer service type 226 indicates a type of customer service needed by the customer.

The staff ID (227) is identification information for identifying a staff assigned to the customer.

The customer identified by the customer ID (223) “IDa” stays in the use area 224 “area A”, has the customer service necessity 225 “necessary”, and needs customer service of the customer service type 226 “B”, that is, “checkout”. A staff identified by a staff ID (227) “staff b” is assigned to the customer.

Further, the customer identified by the customer ID (223) “IDb” stays in the use area 224 “area A”, has the customer service necessity 225 “necessary”, and needs customer service of the customer service type 226 “B”, that is, “checkout”. A staff identified by a staff ID (227) “staff b” is assigned to the customer.

Furthermore, the customer identified by the customer ID (223) “IDc” stays in the use area 224 “area B”, has the customer service necessity 225 “necessary”, and needs customer service of the customer service type 226 “C”, that is, “guidance”, A staff identified by a staff ID (227) “staff c” is assigned to the customer.

(Skeleton Detector 171)

As described above, the skeleton detector 171 determines which area (for example, the area A or the area B described above) each object (that is, a customer) exists in the store 8.

(Posture Determiner 172)

As described in the first embodiment, the posture determiner 172 performs processing by the neural network to determine which of the posture 1, the posture 2, the posture 3, the posture 4, or another posture an object in each frame point cloud included in the point cloud data 133 is in.

Here, in the second embodiment, the posture 1 indicates that the object is in a posture in which, for example, a person is standing upright and is operating the MFP with the right hand. Further, the posture 2 indicates that the object is in a posture in which, for example, a person is standing upright in front of the MFP and holds his or her head with both hands. The posture 3 indicates that the object is, for example, a posture in which a person stands upright at the reception counter 3 and raises one hand above the shoulder. The posture 4 indicates that the object is, for example, a posture in which a person stands upright at the entrance 2 and puts one hand on the chin.

As in the first embodiment, the posture determiner 172 generates the posture list 141 that includes the posture data 141a, 141b, 141c, . . . including the probability of being in the posture 1, the posture 2, the posture 3, and the posture 4 of the second embodiment with a value between 0.0 and 1.0 corresponding to each of the frame point clouds 133a, 133b, 133c, . . . and further including the area information indicating the area where the object exists, and writes the generated posture list 141 in the storage device 115 via the input/output circuit 114.

(Customer Service Determiner 173)

As in the first embodiment, the customer service determiner 173 determines whether customer service is necessary for each object ID (that is, for each customer) with respect to each of pieces of posture data 141a, 141b, 141c, . . . included in the posture list 141, using the value of the posture 1, the value of the posture 2, the value of the posture 3, and the value of the posture 4 of the second embodiment.

Furthermore, in the second embodiment, when it is determined that customer service is necessary, the customer service determiner 173 determines the customer service type indicated by the posture for which it is determined that customer service is necessary.

Specifically, when it is determined that the customer service is necessary using the value of the posture 2, the customer service determiner 173 determines the customer service type as A. When it is determined that the customer service is necessary using the value of the posture 3, the customer service determiner 173 determines the customer service type as B. When it is determined that the customer service is necessary using the value of the posture 4, the customer service determiner 173 determines the customer service type C.

The customer service determiner 173 generates object information including the object ID, the determined value of customer service necessity, the customer service type, and the information indicating the area where the object exists, and writes the object information in the object data via the input/output circuit 114.

In this manner, in the second embodiment, as illustrated in FIGS. 7 and 10, the customer service determiner 173 writes the object list 135 including the object data 135a, 135b, 135c, . . . in the storage device 115. Here, the object information included in each piece of the object data of the second embodiment includes the object ID, the customer service necessity, the customer service type, and the information indicating the area where the object exists.

(Customer List Update Unit 123)

The customer list update unit 123 of the second embodiment writes the object ID, the information indicating the area where the object exists, the customer service necessity, and the customer service type in the object information included in each piece of the object data of the second embodiment as the customer ID (223), the use area (224), the customer service necessity (225), and the customer service type 226 in the customer information 222 of the customer list 221.

(Total Customer Service Time)

(1) Case of Comparative Example

If the staff a serves the customer a and then the customer b, while the staff b serves the customer c according to normal assignment of staffs to each area without considering an appropriate combination of staff and customer, the total time necessary for the staff a (231) to serve the customer a (233) and then the customer b (234) is 16 minutes, and the time necessary for the staff b (232) to serve the customer c (235) is 10 minutes, as illustrated in FIG. 16C.

As a result, the total time necessary for completing the customer service for the customer a, the customer b, and the customer c is 16 minutes.

(2) Case of Second Embodiment

On the other hand, the customer service determination unit 125 according to the second embodiment generates all combinations of [Staff a, b] and [Customer a, b, c].

Next, the customer service determination unit 125 calculates the sums of the customer service times for all the generated combinations.

Next, the customer service determination unit 125 selects a combination corresponding to the shortest customer service time among the sums of the customer service times calculated for all combinations.

In this manner, if the staff a serves the customer c, while the staff b serves the customer a and then serves the customer b, the total time necessary for the staff a (241) to serve the customer c (243) is 12 minutes, and the total time necessary for the staff b (242) to serve the customer a (244) and then serve the customer b (245) is 10 minutes, as illustrated in FIG. 16D.

As a result, the total time necessary for completing the customer service for the customer a, the customer b, and the customer c is 12 minutes.

This total time is shorter than the total time calculated in the case of the comparative example of (1) above.

The customer service determination unit 125 sets or changes the assignment of the customer service target customer for each staff, and writes the correspondence relationship between the staff and the customer in the customer list 221.

As described above, since the time of the customer service for customers in the second embodiment is shorter than that in the comparative example of (1), the customer service for customers can be improved as a whole.

### Operation in Second Embodiment

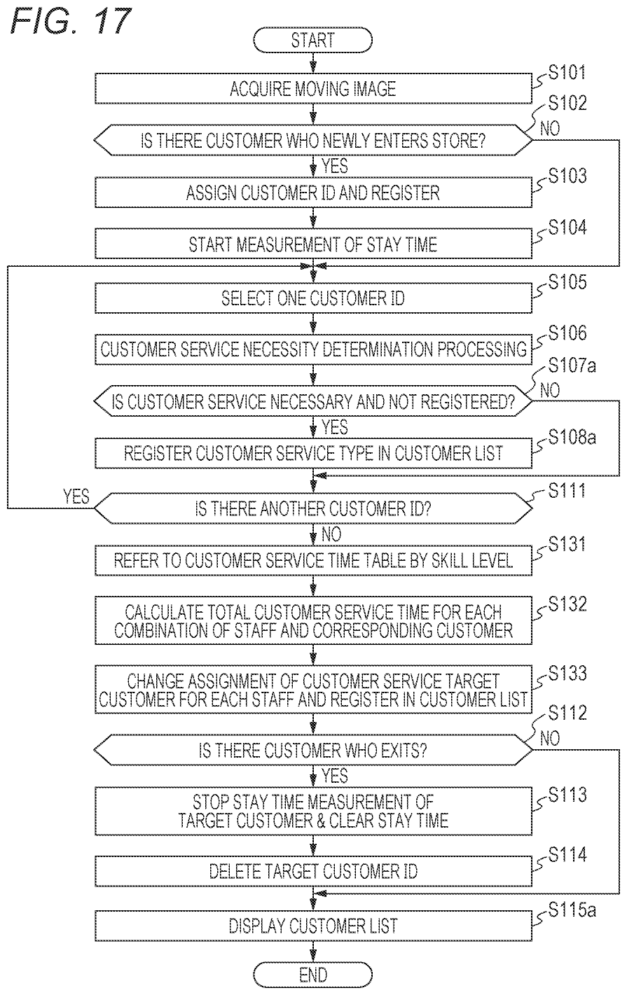

An operation of the customer service management apparatus 10 according to the second embodiment mainly in the main control unit 121 will be described with reference to a flowchart illustrated in FIG. 17.

The procedure illustrated in this flowchart is executed periodically (for example, once every 5 seconds).

Steps S101 to S106, S111, and S112 to S114 in the flowchart illustrated in FIG. 17 are the same as steps S101 to S106, S111, and S112 to S114 illustrated in FIG. 13, respectively, and thus the description thereof is omitted.

Subsequent to step S106, when it is determined that the customer service necessity 165 included in the customer information 162 is “necessary” and that the customer service type is not registered in the customer list 221 (“YES” in step S107a), the customer list update unit 123 registers the customer service type in the customer list 221 (step S108a).

Here, when it is determined that the customer service necessity 165 included in the customer information 162 is “unnecessary” or the customer service type is registered in the customer list 221 (“NO” in step S107a), the customer list update unit 123 does not execute step S108a.

When it is determined that there is no other customer 1D for which the processing has not been completed (“NO” in step S111), the customer service determination unit 125 refers to the customer service time table 201 by skill level (step S131). Next, the customer service determination unit 125 calculates a customer service time of TOTAL for each combination of the staff and the corresponding customer (step S132). Next, the customer service determination unit 125 sets or changes the assignment of the customer service target customer for each staff, and writes the correspondence relationship between the staff and the customer in the customer list 221 (step S133).

Subsequent to step S114, the integrated control unit 122 reads the customer list 221 from the storage device 105, outputs the read customer list 221 to the output circuit 108, and performs control to display the customer list on the monitor 6 (step S115a).

As described above, the operation of mainly the main control unit 121 of the customer service management apparatus 10 according to the second embodiment is ended.

### SUMMARY

According to the second embodiment, the total time of the customer service for customers can be shortened, and the customer service for customers can be improved as a whole.

Note that, in the second embodiment, the total time of the customer service for customers is shortened, but the embodiment is not limited thereto.

The assignment of staffs to customers may be determined so that the time until customer service in the entire specific area is completed becomes shorter (becomes smaller than a predetermined threshold value). Here, the specific area is, for example, an area where there are more customers staying than in other areas.

As described above, in the second embodiment, when it is determined that customer service for a customer is necessary, the customer list update unit 123 (determiner) determines the correspondence relationship between the customer for which it is determined that customer service is necessary and a customer service staff providing customer service.

Here, a plurality of staffs who provide customer service may be arranged in the store 8. In addition, the skill level of customer service may be different for each staff. The customer list update unit 123 may determine a correspondence relationship between a customer who needs customer service and a staff providing customer service on the basis of the skill level of the staff.

As described above, customer service is provided to a customer who needs customer service according to the determined correspondence relationship between the customer and a customer service staff, and an excellent effect that it is possible to meet the desires of customers can be obtained.

In addition, there may be a plurality of types of customer service to be provided to a customer who needs customer service. A plurality of staffs providing customer service is arranged in a region in the store 8. For each staff, the customer service time necessary for customer service is different for each customer service. The customer service determiner 173 estimates customer service corresponding to a customer who needs customer service. The customer list update unit 123 (determiner) may determine the correspondence relationship between the customer and the staff depending on the customer service time by the staff and the type of customer service needed by the customer.

In addition, the customer list update unit 123 may determine the correspondence relationships between a plurality of staffs and a plurality of customers in such a manner that the sum of the customer service times for one or more customers for each staff is the shortest.

### 2.2 Modification

(1) The region in the store 8 may include a plurality of sub regions.

In addition, the number calculator 174 may calculate, for each sub region, the number of customers who stay in the sub region and needs customer service on the basis of the received moving image.

The customer list update unit 123 (determiner) may determine whether or not the number of customers calculated for each sub region is equal to or more than a predetermined threshold value, and when it is determined that the number of customers is equal to or more than the predetermined threshold value, it may be determined to arrange a staff with a skill level higher than the predetermined skill level threshold value to the sub region. Here, the predetermined threshold value may be determined according to the size of the sub region, for example. In addition, the predetermined threshold value may be determined according to the number of customers that can be accommodated in the sub region, for example. As one specific example, the predetermined threshold value may be 50% of the number of customers that can be accommodated in the sub region to the maximum. In addition, the predetermined threshold value may be determined according to the number of customers that can be handled by the current staff in the sub region, for example. As a specific example, the predetermined threshold value may be 50% of the maximum number of customers that can be handled by the current staff in the sub region.

(2) The region in the store 8 may include a plurality of sub regions.

In addition, the number calculator 174 may calculate, for each sub region, the number of customers who stay in the sub region and needs customer service on the basis of the received moving image.

The customer list update unit 123 (determiner) compares the number of customers who stay in the first sub region and need customer service with the number of customers who stay in the second sub region and need customer service. When the number of customers who stay in the first sub region and need customer service is larger than the number of customers who stay in the second sub region and need customer service, the customer list update unit 123 may preferentially assign a staff with a skill level higher than a predetermined skill level threshold value to the customer who stays in the first sub region and needs customer service.

### 5 Other Modifications

(1) In each of the above embodiments, the customer service management system 1 includes one camera 5 and one customer service management apparatus 10. However, the embodiments are not limited to this mode.

The customer service management system may include a plurality of cameras and a customer service management apparatus. The customer service management apparatus receives a moving image from each camera. The customer service management apparatus may perform the above-described recognition processing on the plurality of received moving images.

As described above, since image-capturing is performed by the plurality of cameras, it is possible to reduce blind spots that are not image-captured in the store 8.

(2) In the above embodiment, the monitor 6 is installed in the reception counter 3.

However, the embodiment is not limited to this.

The reception counter 3 may be provided with a personal computer, a monitor connected to the personal computer, a keyboard, and the like.

The personal computer is connected to the customer service management apparatus 10 via a network.

The integrated control unit 122 of the customer service management apparatus 10 reads the customer list 161 from the storage device 105, and transmits the read customer list 161 to the personal computer via the network communication circuit 106 and the network. The personal computer displays the customer list 161 on a monitor.

In this manner, the customer service management apparatus 10 can be installed at a remote place away from the store 8.

(3) In each of the above embodiments, one camera 5 is fixedly installed in the store 8. However, the embodiments are not limited to this mode.

Instead of the camera 5 or together with the camera 5, a robot that can autonomously move around in the store 8 may be arranged in the store 8. The robot includes an autonomous operation mechanism that enables the robot to move by driving wheels or the like, a camera, a control device, a wireless communication circuit that performs wireless communication, and the like. The camera captures the inside of the store 8 and generates a moving image. The wireless communication circuit transmits the generated moving image to the customer service management apparatus 10 via the wireless communication circuit.

The customer service management apparatus 10 receives a moving image from the robot. The customer service management apparatus 10 uses the moving image received from the robot and determines the order of customer service or the correspondence relationship between the customer and the customer service staff as described in each of the above embodiments.

As described above, in the store 8, since the camera included in the circulating robot captures an image, it is possible to reduce blind spots that are not image-captured in the store 8.

(4) The above embodiment and the above modification examples may be combined.

A customer service management apparatus according to the present disclosure provides customer service to a customer who needs customer service according to the determined order of customer service or according to the determined correspondence relationship between the customer and a customer service staff, has an excellent effect that it is possible to meet the desires of customers, and is useful as a technology for managing a customer service method for a customer staying in a predetermined region.

Although embodiments of the present invention have been described and illustrated in detail, the disclosed embodiments are made for purposes of illustration and example only and not limitation. The scope of the present invention should be interpreted by terms of the appended claims.

What is claimed is:

1. A customer service management apparatus that manages a customer service method for a customer staying in a predetermined region, the apparatus comprising:
a receiver that receives an image generated by image-capturing with a plurality of customers as subjects;
a customer service determiner that determines whether or not customer service is necessary for each of the customers on the basis of the received image; and
a hardware processor that determines, when it is determined that customer service is necessary for a plurality of customers, an order of customer service for the plurality of customers for which customer service is necessary.

2. The customer service management apparatus according to claim 1, wherein
the hardware processor further calculates a time during which each of the customers stays in the region, and
determines, using the calculated time, the order of customer service for the plurality of customers for which it is determined that customer service is necessary.

3. The customer service management apparatus according to claim 2, wherein
the hardware processor gives priority, in the order of customer service, to a customer staying in the region for a time longer than a predetermined threshold value among the plurality of customers for which it is determined that customer service is necessary.

4. The customer service management apparatus according to claim 1, wherein
the hardware processor further calculates, for each of the customers for which it is determined that customer service is necessary, a time during which the customer stays in the region from a time point when it is determined, by the customer service determiner, that customer service is necessary, and
determines the order of customer service using the calculated time for the plurality of customers for which it is determined that customer service is necessary.

5. The customer service management apparatus according to claim 4, wherein
the hardware processor gives priority, in the order of customer service, to a customer staying in the region for a time longer than a predetermined threshold value among a plurality of customers for which it is determined that customer service is necessary.

6. The customer service management apparatus according to claim 1, wherein
an order of customer service is determined according to an order in which each of the customers enters the region,
the hardware processor further calculates a time during which each of the customers stays in the region,
when it is determined, by the customer service determiner, that customer service is necessary for one customer, the hardware processor determines to increase the order of customer service by one for the customer, and
the hardware processor determines whether or not the calculated time is equal to or more than a predetermined threshold value for the customer for which it is determined that customer service is necessary, and
when it is determined that the calculated time is equal to or more than the predetermined threshold value, the hardware processor determines to increase the order of the customer service by one.

7. The customer service management apparatus according to claim 1, wherein
the region includes a plurality of sub regions,
the customer service management apparatus further comprising a number calculator that calculates, for each of the sub regions, a number of customers staying in the sub region on the basis of the received image, and
the hardware processor determines the order of customer service in the sub region by using the number of customers calculated for each of the sub regions.

8. The customer service management apparatus according to claim 7, wherein
the hardware processor determines whether or not the number of customers calculated for each of the sub regions is equal to or more than a predetermined threshold value, and when it is determined that the calculated number of customers is equal to or more than the predetermined threshold value, the hardware processor increases the order of customer service by one for all customers staying in the sub region.

9. The customer service management apparatus according to claim 1, wherein
the region includes a plurality of sub regions,
a plurality of customers stays in each of the sub regions,
the customer service management apparatus further comprising a number calculator that calculates, for each of the sub regions, a number of customers who stay in the sub region and need customer service on the basis of the received image,
the hardware processor calculates, for each of the customers who need customer service, a time during which the customer stays in each of the sub regions from a time point when it is determined, by the customer service determiner, that customer service is necessary, and
determines, by using the calculated time, the order of customer service by giving priority to a customer staying longer than a predetermined threshold value for each of the sub regions.

10. A customer service management apparatus that manages a customer service method for a customer staying in a predetermined region, the apparatus comprising:
a receiver that receives an image generated by image-capturing with a plurality of customers as subjects;
a customer service determiner that determines whether or not customer service is necessary for each of the customers on the basis of the received image; and
a hardware processor that determines, when it is determined that customer service is necessary for a customer, a correspondence relationship between the customer for which it is determined that customer service is necessary and a customer service staff who provides customer service.

11. The customer service management apparatus according to claim 10, wherein
a plurality of customer service staffs is arranged in the region, and each of the customer service staffs has a different skill level of customer service, and
the hardware processor determines a correspondence relationship between a customer who needs customer service and a customer service staff on the basis of a skill level of the customer service staff.

12. The customer service management apparatus according to claim 11, wherein
the region includes a plurality of sub regions,
the customer service management apparatus further comprising a number calculator that calculates, for each of the sub regions, a number of customers who stay in the sub region and need customer service on the basis of the received image, and
the hardware processor determines whether or not the number of customers calculated for each of the sub regions is equal to or more than a predetermined threshold value, and when it is determined that the number of customers is equal to or more than the predetermined threshold value, the hardware processor determines to arrange a customer service staff with a skill level higher than a predetermined skill level threshold value in the sub region.

13. The customer service management apparatus according to claim 11, wherein
the region includes a plurality of sub regions,
the customer service management apparatus further comprising a number calculator that calculates, for each of the sub regions, a number of customers who stay in the sub region and need customer service on the basis of the received image, and
the hardware processor compares a number of customers who stay in a first sub region and need customer service with a number of customers who stay in a second sub region and need customer service, and when the number of customers who stay in the first sub region and need customer service is more than the number of customers who stay in the second sub region and need customer service, the hardware processor preferentially assigns a customer service staff with a skill level higher than a predetermined skill level threshold value to a customer who stays in the first sub region and needs customer service.

14. The customer service management apparatus according to claim 10, wherein
there is a plurality of types of customer service to be provided to a customer who needs customer service,
a plurality of customer service staffs who provide customer service is arranged in the region, and
for each of the customer service staffs, a customer service time necessary for customer service is different for each customer service, and
the customer service determiner further estimates a customer service corresponding to a customer who needs customer service, and
the hardware processor determines a correspondence relationship between a customer and a customer service staff depending on a customer service time by the customer service staff and a type of customer service needed by the customer.

15. The customer service management apparatus according to claim 14, wherein
the hardware processor determines correspondence relationships between a plurality of customer service staffs and a plurality of customers in such a manner that a sum of customer service times for one or more customers of each of the customer service staffs is shortest.

16. The customer service management apparatus according to claim 1, further comprising:
a detector that detects, by using the received image, point information indicating a skeleton point on a skeleton of the customer or an end point on a contour of the customer captured in the image; and
a posture determiner that determines a posture of the customer by using the detected point information, wherein
the customer service determiner determines whether customer service is necessary for the customer by using the posture determined by the posture determiner.

17. The customer service management apparatus according to claim 16, wherein
the posture determiner determines whether the posture of the customer is a posture in which his or her hand is placed on a chin or the posture of the customer is a posture in which his or her head is held by hands, and
the customer service determiner determines, when it is determined that the posture of the customer is a posture in which his or her hand is placed on a chin, or when it is determined that the posture of the customer is a posture in which his or her head is held by hands, that customer service for the customer is necessary.

18. A customer service management system comprising a customer service management apparatus that manages a customer service method for a customer staying in a predetermined region, and an imaging device that generates an image by image-capturing with a plurality of customers as subjects, wherein
the customer service management apparatus includes:
a receiver that receives an image generated by image-capturing with a plurality of customers as subjects;
a customer service determiner that determines whether or not customer service is necessary for each of the customers on the basis of the received image; and
the hardware processor that determines, when it is determined that customer service is necessary for a plurality of customers, an order of customer service for a plurality of customers for which customer service is necessary.

19. A customer service management method used in a customer service management apparatus that manages a customer service method for a customer staying in a predetermined region, the method comprising:
receiving an image generated by image-capturing with a plurality of customers as subjects;
determining whether or not customer service is necessary for each of the customers on the basis of the received image; and
determining, when it is determined that customer service is necessary for a plurality of customers, an order of customer service for a plurality of customers for which it is determined that customer service is necessary.

20. A non-transitory recording medium storing a computer readable computer program used in a customer service management apparatus that manages a customer service method for a customer staying in a predetermined region, the program causing a customer service management apparatus that is a computer to perform:
receiving an image generated by image-capturing with a plurality of customers as subjects;
determining whether or not customer service is necessary for each of the customers on the basis of the received image, and
determining, when it is determined that customer service is necessary for a plurality of customers, an order of customer service for a plurality of customers for which it is determined that customer service is necessary.

21. A customer service management system including a customer service management apparatus that manages a customer service method for a customer staying in a predetermined region, and an imaging device that generates an image by image-capturing with a plurality of customers as subjects, the customer service management system comprising:
a receiver that receives an image generated by image-capturing with a plurality of customers as subjects;
a customer service determiner that determines whether customer service is necessary for each of the customers on the basis of the received image; and
a hardware processor that determines, when it is determined that customer service is necessary for a customer, a correspondence relationship between the customer for which it is determined that customer service is necessary and a customer service staff who provides customer service.

22. A customer service management method used in a customer service management apparatus that manages a customer service method for a customer staying in a predetermined region, the method comprising:
receiving an image generated by image-capturing with a plurality of customers as subjects;
determining whether or not customer service is necessary for each of the customers on the basis of the received image; and
determining, when it is determined that customer service is necessary for a customer, a correspondence relationship between the customer for which it is determined that customer service is necessary and a customer service staff who provides customer service.

23. A non-transitory recording medium storing a computer readable computer program used in a customer service management apparatus that manages a customer service method for a customer staying in a predetermined region, the program causing a customer service management apparatus that is a computer to perform:
receiving an image generated by image-capturing with a plurality of customers as subjects;
determining whether or not customer service is necessary for each of the customers on the basis of the received image; and
determining, when it is determined that customer service is necessary for a customer, a correspondence relationship between the customer for which it is determined that customer service is necessary and a customer service staff who provides customer service.

24. The customer service management apparatus according to claim 10, further comprising:
a detector that detects, by using the received image, point information indicating a skeleton point on a skeleton of the customer or an end point on a contour of the customer captured in the image; and
a posture determiner that determines a posture of the customer by using the detected point information, wherein
the customer service determiner determines whether customer service is necessary for the customer by using the posture determined by the posture determiner.
